(19) United States
(12) Patent Application Publication
(10) Pub. No.: US 2019/0375456 A1
(43) Pub. Date: Dec. 12, 2019

(54) Galvanized Vehicle Frame Assemblies and Methods for Forming the Same

(71) Applicant: Demountable Concepts, Inc., Glassboro, NJ (US)

(72) Inventors: Rustin Arthur Cassway, Cherry Hill, NJ (US); Albert Stephen Perry, Mullica Hill, NJ (US); David John Fisher, Berlin, NJ (US)

(73) Assignee: Demountable Concepts, Inc.

(21) Appl. No.: 16/436,865

(22) Filed: Jun. 10, 2019

Related U.S. Application Data
(60) Provisional application No. 62/684,079, filed on Jun. 12, 2018.

(51) Int. Cl. B62D 21/02; B62D 27/02; B62D 25/20; B62D 21/20

(52) U.S. Cl. CPC B62D 21/02; B62D 21/20; B62D 25/2054; B62D 27/023

(57) ABSTRACT

The present invention relates to a vehicle frame assembly and methods of forming such assemblies as well as bracket for use in such assemblies. The assemblies include crossmembers arranged transversely and one or more rails extending longitudinally with respect to the crossmembers. Brackets are provided for connecting the crossmembers to the rail, and each bracket includes a first plate, a second plate and a connection section connecting the first plate to the second plate and bridging an area between the first and second plates. The first plates and the second plates of the brackets are configured to engage and be secured to either a surface of the at least one rail or a surface of the plurality of crossmembers. The brackets are configured so that when the first plates are secured to the surface of a rail, the second plates are secured to the surface of a crossmember and when the first plates are secured to the surface of a crossmember, the second plates are secured to the surface of a rail. The plurality of crossmembers or the at least one rail or both are galvanized, and may be galvanized before assembly of the frame. The brackets may also be galvanized.

### CROSS-REFERENCE TO RELATED APPLICATIONS

This U.S. Non-Provisional Patent Application claims the benefit under 35 U.S.C. § 119(e) to U.S. Provisional Patent Application No. 62/684,079, entitled, “Galvanized Vehicle Frame Assemblies and Methods for Forming the Same,” the entire disclosure of which is incorporated herein by reference.

### BACKGROUND OF THE INVENTION

### Field of the Invention

The present invention relates to vehicle frame assemblies. Specifically, the present invention relates to vehicle frame assemblies, such as truck or trailer frame assemblies, and methods for preparing vehicle frame assemblies without the need for welding, including methods and assemblies in which the components may be galvanized prior to or after assembling the components to make the vehicle frame assembly for corrosion prevention and wherein components of the vehicle frame assemblies are connected via brackets designed to bridge and connect the assembly components through such brackets and associated fasteners.

### Description of Related Art

Vehicle frame assemblies serve as support structures on which a vehicle or trailer can be positioned. Many conventional vehicle frame assemblies are formed using a number of longitudinal beams or rails and crossbeams or crossmembers. The longitudinal beams and crossbeams of such vehicle frame assemblies are often formed from metal and are generally joined to one another by welding. The resulting welded vehicle frame assembly is sometimes coated or galvanized to inhibit corrosion of the vehicle frame assembly. The galvanized coating can be applied by spraying, but is commonly applied by dipping the entire frame assembly in a tank filled with a galvanizing fluid, such as molten zinc. Thus, the welded vehicle frame assembly is typically galvanized all at once. However, such conventional methods for preparing vehicle frame assemblies have a number of drawbacks.

Welding the components of a vehicle frame assembly requires highly skilled welders to prepare the vehicle frame assemblies, increasing the cost of assembling the vehicle frame assembly. Further, welding restricts the materials that can be used to construct the vehicle frame assembly as not all metals can be practically welded to one another for strength applications. For example, welding generally would not be used to successfully prepare a vehicle frame assembly having aluminum crossbeams and a stainless steel, longitudinal beam. Additionally, frame assemblies formed by welding cannot be disassembled once the longitudinal beams and crossbeams are welded together. As a result, the vehicle frame assembly cannot be transported in pieces and assembled at a desired location. Instead, it is generally transported as a completed vehicle frame assembly. Transporting the completed frame assembly requires a considerable amount of space and can be cumbersome, inconvenient expensive and poses a risk of damage to the completed frame assembly. Further, as the whole vehicle frame assembly is galvanized at once, large tanks are required into which the entire vehicle frame assembly can be dipped, which also requires significant space, slowing down the overall process efficiency. Galvanizing is generally not performed prior to welding of the components of the vehicle frame assembly, as the welding process can damage or deteriorate the galvanized coating.

To overcome these drawbacks, some methods of preparing vehicle frame assemblies are known in which the beams of the vehicle frame assembly are galvanized prior to assembling the vehicle frame assembly. One such reference is International Patent Application Publication No. WO 03/053770 which describes a method for assembling a platform underframe for motor vehicles including bolted, punched, bent-plate elements and specific parts having precise perforations. To avoid welding of the parts, the parts of the assembly can be galvanized prior to assembly.

U.S. Patent Application Publication No. 2007/0194564 discloses a method of assembling a trailer including a frame having fabricated beams with a web section and a pair of opposing flanges. The flanges may include web-receiving slots. The flanges may also include obtuse ends which may include recesses for receiving fasteners used to secure crossmembers. Securement is achieved using fasteners, such as self-piercing rivets. The web and flanges may be pre-coated to provide a finished beam upon assembly so that welding is not required.

While these references disclose coating or galvanization of vehicle frame assembly parts prior to assembling the vehicle frame assembly, such prior art non-welded frame connections are not yet believed to provide a secure and strong connection between the longitudinal beams and crossbeams so as to enable the vehicle frame assembly that is able to reliably support heavy loads and maintain its integrity when subjected to shear and torsional stresses. Directly connecting such the beams with fasteners is generally believed to yield a connection that is not sufficiently strong. Further, it can be difficult to properly align the longitudinal beams and crossbeams for placing connecting fasteners.

While various brackets are generally known, brackets that are specifically designed for connection of beams and crossbeams of a vehicle frame assembly while facilitating proper alignment of the bracket on the beam or crossbeam and maintaining the strength and integrity of the assembly are not believed to be known in the art.\

Therefore, there is a need in the art for a vehicle frame assembly where the components can be galvanized before assembling the components to form the vehicle frame assembly and where the components can be secured without the use of welding while ensuring a strong and stable connection between the longitudinal beams and crossbeams and maintaining proper alignment as well as providing a way to easily disassemble the frame for transportation and to reassemble it at a lower cost. Further, there is a need in the art for a vehicle frame assembly that facilitates proper positioning of the longitudinal beams and crossbeams and that facilitates connection of the beams using appropriate fasteners which may also be galvanized.

### BRIEF SUMMARY OF THE INVENTION

The invention includes a vehicle frame assembly, comprising a plurality of crossmembers arranged generally transversely and at least one rail extending generally longitudinally with respect to the plurality of crossmembers; a plurality of brackets each for connecting the plurality of crossmembers to the at least one rail, wherein each bracket comprises a first plate, a second plate and a connection section connecting the first plate to the second plate, the connection section configured to bridge an area between the first plate and the second plate; wherein the first plates and the second plates of the plurality of brackets are configured to engage and be secured to either a surface of the at least one rail or a surface of the plurality of crossmembers; wherein the plurality of brackets are configured such that when the first plates are secured to the surface of the at least one rail, the second plates are secured to the surface of the plurality of crossmembers and when the first plates are secured to the surface of the plurality of crossmembers, the second plates are secured to the surface of the at least one rail; and wherein at least one of the plurality of crossmembers and the at least one rail are galvanized.

The plurality of crossmembers and the at least one rail of the vehicle frame assembly may be pre-galvanized before the assembly is made. Each of the crossmembers of the plurality of crossmembers of the vehicle frame assembly may optionally be an I-beam having a web and flanges. Similarly, each of the at least one rail may also be an I-beam or C-beam having a web and flanges. In one embodiment herein, the plurality of crossmembers and the at least one rail are all I-beams, each I-beam comprising a vertically oriented web having a first end and a second end and horizontally oriented flanges on the first end and the second end of the vertically oriented web. In another embodiment, the plurality of crossmembers may be I-beams while the rail(s) are C-beams.

In one embodiment of the vehicle frame assembly, the vehicle frame assembly comprises two rails. In such embodiments, the plurality of crossmembers are arranged so as to be substantially parallel and spaced apart in a first plane, the two rails are arranged so as to be substantially parallel and spaced apart in a second plane, and the first plane and the second plane are generally parallel to each other. The first plane may be positioned above the second plane so that the plurality of crossmembers are stacked on the two rails.

On an upper side of the assembly each of the brackets in the plurality of brackets may be used to connect a flange of one of the at least one rail to a web of one of the plurality of crossmembers. On a lower side of the assembly, each of the brackets in the plurality of brackets may be used to connect a web of one of the at least one rail to a flange of one of the plurality of crossmembers.

Preferably, the plurality of brackets is galvanized, and more preferably the brackets are galvanized before the assembly of the frame.

Alternatively, on an upper side of the assembly, each of the plurality of brackets connects a flange of one of the at least one rail to a flange of one of the plurality of crossmembers. Similarly, on a lower side of the assembly, each of the plurality of brackets connects a flange of one of one of the plurality of crossmembers to a flange of one of the at least one rail.

In one embodiment of the bracket, the bracket is configured such that the first plate of each of the plurality of brackets is arranged in a plane that is perpendicular to a plane of the second plate, and the connection section connects an interior end of the first plate to an interior end of the second plate. In such an embodiment, on an upper side of the assembly, the first plate of each of the plurality of brackets connects to a flange of one of the at least one rail and the second plate connects to a web of one of the plurality of crossmembers, and the connection section is in facing engagement with the flange of the one crossmember of the plurality of crossmembers. Further, on a lower side of the assembly, the first plate of each of the plurality of brackets connects to a flange of one of the plurality of crossmembers and the second plate connects to a web of one of the at least one rail, and the connection section is in facing engagement with the flange of the one rail of the at least one rail.

In another embodiment of the bracket, the first plate of each bracket of the plurality of brackets is arranged in a plane that is perpendicular to a plane of the second plate of the bracket, the connection section connects an interior bend of the first plate with an interior bend of the second plate, and the connection section is in a plane that is perpendicular to both the plane of the first plate and the plane of the second plate. In such embodiments, on an upper side of the assembly, the first plate of each bracket of the plurality of brackets is connected to a flange of one of the at least one rail and the second plate of the bracket is connected to a web of one of the plurality of crossmembers, and the connection section extends over a flange of the crossmember of the plurality of crossmembers. Further, on a lower side of the assembly, the first plate of each bracket of the plurality of brackets is connected to a flange of one of the plurality of crossmembers and the second plate is connected to a web of one of the at least one rail, and the connection section extends over a flange of the rail of the at least one rail.

The first plate of each bracket of the plurality of brackets may be in facing engagement with a flange of the at least one rail, and the second plate of the bracket may be in facing engagement with the web of one of the plurality of crossmembers.

In other words, when installed on an upper side of the assembly, the first and second plates may be installed so as to be in facing engagement respectively with one rail of the at one least rail and with one crossmember of the plurality of crossmembers, and the connection section extends over a flange of the crossmember of the plurality of crossmembers, and when installed on a lower side of the assembly, the first and second plates may be in facing engagement respectively with the crossmember and the rail and the connection section extends over a flange of the rail.

In another embodiment of the bracket, the first plate of each bracket of the plurality of brackets is arranged in a first plane that is substantially parallel to a second plane in which the second plate is arranged, and the connection section connects an interior end of the first plate and an interior end of the second plate. In such embodiments, on a lower side of the assembly, the first plate of each bracket of the plurality of brackets is connected to a flange of one of the plurality of crossmembers and the second plate is connected to a flange of one of the at least one rail.

In embodiments herein, the first and second plates of each of the plurality of brackets are preferably secured to either of the surfaces of the at least one rail or the surface of the plurality of crossmembers via a plurality of fasteners.

The invention further includes a vehicle frame assembly, comprising a plurality of crossmembers arranged generally transversely and at least one rail extending generally longitudinally with respect to the plurality of crossmembers; a plurality of brackets for connecting the plurality of crossmembers to the at least one rail, wherein each bracket comprises a first plate, a second plate and a connection section configured to bridge an area between the first plate and the second plate; wherein the first plate of each bracket is configured to engage and be secured to a surface of the at least one rail and the connection section is configured to be in at least partial engagement with a surface of a crossmember of the plurality of crossmembers; and wherein at least one of the plurality of crossmembers and the at least one rail are galvanized.

In this embodiment of the vehicle frame assembly, the plurality of crossmembers and the at least one rail may be pre-galvanized before the assembly is made. Further, the plurality of crossmembers and the at least one rail are preferably formed from fabricated metal sections.

Each of the plurality of crossmembers in this embodiment further comprises a web with a first end and a second end, and a flange arranged perpendicularly to the web of the crossmember extends outwardly on each of the first end and the second end of the web of the crossmember, and the flanges of the crossmembers preferably extend in opposing directions.

The vehicle frame assembly may have two rails. When two rails are used, the two rails are preferably arranged in a first plane and the plurality of crossmembers are arranged in a second plane that is substantially parallel to the first plane.

Further, in the embodiment of the vehicle frame assembly in which the bracket has a connection section that at least partially engages a surface of the crossmember, the bracket may be configured such that the first plate and second plate of each bracket of the plurality of brackets are parallel and the connection section connects an interior end of the first plate to an interior end of the second plate, and the connection section is perpendicular to the first plate and the second plate. On an upper side of the assembly, the first plate of each bracket of the plurality of brackets may be connected to a flange of a rail of the at least one rail, and the connection section may extend over a web of the rail and connect to a web of a crossmember of the plurality of crossmembers.

In preferred embodiments of this assembly, the at least one rail may comprise a web with an outer flange and an inner flange. The at least one rail may further include at least one tab, each tab being positioned on the inner flange of the rail and aligned so as to engage the second plate of one of the plurality of brackets and securing the second plate of each bracket to the tab of the at least rail. As with the prior assembly, in this assembly embodiment, the brackets may be secured to the rails and crossmembers by fasteners

The present invention further includes methods for forming a vehicle frame assembly. In one embodiment the method comprises providing at least one rail, a plurality of crossmembers, and a plurality of brackets, wherein each of the brackets comprises a first plate, a second plate and a connection section bridging an area between the first plate and the second plate; galvanizing the at least one rail and/or the plurality of crossmembers; assembling the vehicle frame assembly by arranging the at least one rail generally longitudinally and the plurality of crossmembers generally transversely to the at least one rail; and connecting each of the plurality of crossmembers to one rail of the at least one rail by engaging and securing the first plate of each bracket of the plurality of brackets with a surface of one of the at least one rail or one of the plurality of crossmembers and connecting the second plate to the surface of the rail or the crossmember, wherein when the first plate is secured to the surface of the rail, the second plate is secured to the surface of the crossmember and when the first plate is secured to the surface of the crossmember, the second plate is secured to the surface of the at least one rail.

In such methods, galvanizing the at least one rail and/or the plurality of crossmembers may be performed prior to assembling the vehicle frame assembly.

In some embodiments of the method of forming a vehicle frame assembly, there may be two rails such that assembling the vehicle frame assembly includes arranging the plurality of crossmembers and the rails so that each of the rails is substantially parallel and spaced apart in a first plane, each of the plurality of crossmembers is substantially parallel and spaced apart in a second plane, and the first and second planes are substantially parallel to each other. The method may optionally include stacking the plurality of crossmembers on the at least one rail.

In one embodiment of the method, the plurality of crossmembers and the at least one rail are I-beams, each I-beam comprises a vertically oriented web having a first end and a second end and horizontally oriented flanges on the first end and the second end of the vertically oriented web, and further comprising connecting each crossmember of the plurality of crossmembers to one of the at least one rail by connecting each of the plurality of brackets to a flange of one of the at least one rail and a web of one of the plurality of crossmembers.

The method of preparing a vehicle frame assembly may comprise brackets having any of the configurations described above with respect to the brackets used to form the vehicle frame assembly.

The method may further comprise securing the plurality of brackets to the at least one rail and the plurality of crossmembers using fasteners.

A further method of forming a vehicle frame assembly is provided herein that comprises providing at least one rail, a plurality of crossmembers, and a plurality of brackets, wherein each of the brackets comprises a first plate, a second plate and a connection section bridging the an area between first plate and the second plate; galvanizing the at least one rail and/or the plurality of crossmembers; assembling the vehicle frame assembly by arranging the at least one rail generally longitudinally and the plurality of crossmembers generally transversely to the at least one rail; and connecting each crossmember of the plurality of crossmembers to one rail of the at least one rail by engaging and securing the first plate of each brackets of the plurality of brackets with a surface of the at least one rail, and engaging and securing the connection section of each of the brackets of the plurality of brackets with a surface of the crossmember of the plurality of crossmembers.

This method may further comprise engaging and securing a second plate of each bracket of the plurality of brackets with a tab of the at least one rail. The securement may be carried out by securing the plurality of brackets to the at least one rail and the plurality of crossmembers using fasteners.

The method may also further comprise connecting the first plate of each bracket to an outer flange of the at least one rail, and connecting the connection section to a web of the crossmember of the plurality of crossmembers.

The present invention further relates to brackets for a vehicle frame assembly as described herein, wherein the brackets include a first plate, a second plate and a connection section connecting the first plate and the second plate. The brackets may include metal and be galvanized. Further, the brackets may include apertures on the first plate and/or the second plate of each bracket for receiving fasteners.

In one embodiment, the invention includes a bracket for assembly a vehicle frame assembly, comprising: a first plate, a second plate and a connection section connecting an interior end of the first plate to an interior end of the second plate and the connection section bridging an area between the first plate and the second plate, wherein the first plate and the second plate are each configured such that upon installation of a vehicle frame assembly, the first plate and the second plate are able to engage and be secured to a rail or crossmember of a vehicle frame assembly and the connection section is configured for engaging a flange of a rail or a crossmember of a vehicle frame assembly located between the first plate and the second plate.

In this embodiment, the first plate may be arranged in a plane that is perpendicular to a plane in which the second plate is arranged. The connection section of the bracket may comprise a first portion adjacent to the first plate, and the first portion may be inclined, and the connection section may further comprise a second portion adjacent to the second plate, and the second portion may be substantially parallel to the first plate.

The interior ends of the first plate and the second plates may be in the form of interior bends, and the first plate may be arranged in a plane that is perpendicular to a plane in which the second plate is arranged. In such embodiment, the connection section may be also arranged in a plane that is perpendicular to both the first plate and the second plate. The connection section in this embodiment is preferably substantially planar. The first plate may also be alternatively arranged in a first plane and the second plate is arranged in a second plane that is substantially parallel to the first plane and is elevated above the first plane. In such an embodiment, the second plate preferably has a width that is greater than a width of the first plate, wherein the width of the first and second plates is measured in a direction transverse to a longitudinal axis of the bracket.

In a further embodiment herein, the invention includes a bracket for assembling a vehicle frame assembly, that comprises a first plate, a second plate, and a connection section connecting an interior end of the first plate to an interior end of a second plate and bridging an area between the first plate and the second plate, wherein the first plate and the second plate are substantially parallel to one another and the connection section is perpendicular to the first plate and the second plate, wherein the first plate is configured such that upon installation of a vehicle frame assembly, the first plate is able to engage and be secured to a rail of a vehicle frame assembly and the connection section is configured for engaging and being secured to a web of a crossmember of a vehicle frame assembly.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a top perspective view of an upper side of a vehicle frame assembly in accordance with one embodiment of the present invention;

FIG. 2 is an enlarged perspective view of a portion of the vehicle frame assembly of FIG. 1;

FIG. 3 is a bottom perspective view of the lower side of the vehicle frame assembly of the embodiment of FIG. 1;

FIG. 4 is an enlarged perspective view of a portion of the vehicle frame assembly of FIG. 3;

FIG. 5 is an end elevational view of a rail of the vehicle frame assembly of FIG. 1;

FIG. 6 is a side elevational view of a rail of FIG. 5;

FIG. 6A is an enlarged view of a portion of the rail of the vehicle frame assembly of FIG. 6;

FIG. 7 is a top elevational view of the rail of FIG. 5;

FIG. 7A is an enlarged view of a portion of the rail of FIG. 7;

FIG. 8 is an end elevational view of a crossmember of the vehicle frame assembly of FIG. 1;

FIG. 9 is a side elevational view of a crossmember of the vehicle frame assembly of FIG. 8;

FIG. 9A is an enlarged view of a portion of the crossmember of FIG. 9;

FIG. 10 is a bottom elevational view of the crossmember of FIG. 8;

FIG. 10A is an enlarged view of a portion of the crossmember of FIG. 10;

FIG. 11 is a perspective view of one embodiment of a bracket for use in embodiments of the vehicle frame assemblies of the present invention as shown in the embodiment of the assembly in FIG. 1;

FIG. 12 is a side elevational view of the bracket of FIG. 11;

FIG. 12A is a top perspective view of an upper side of a further embodiment of a vehicle frame assembly of the present invention in which the rails are formed as C-beams;

FIG. 12B is an enlarged perspective view of a portion of the vehicle frame assembly of FIG. 12A;

FIG. 12C is a bottom perspective view of the lower side of the embodiment of the vehicle assembly of FIG. 12A;

FIG. 12D is an enlarged perspective view of a portion of the vehicle frame assembly of FIG. 12C;

FIG. 13 is a top perspective view of an upper side of a further embodiment of a vehicle frame assembly of the present invention;

FIG. 14 is an enlarged perspective view of a portion of the vehicle frame assembly of FIG. 13;

FIG. 15 is a bottom perspective view of the lower side of the embodiment of the vehicle frame assembly of FIG. 13;

FIG. 16 is an enlarged perspective view of a portion of the lower side of the vehicle frame assembly of FIG. 15;

FIG. 17 is a perspective view of a further embodiment of a bracket for use in the vehicle frame assemblies of the present invention and is shown in the embodiment of an assembly in FIG. 13;

FIG. 18 is a side view of the bracket of FIG. 17 taken along the plane of the outer surface of the first plate of the bracket;

FIG. 19 is a side elevational view of the bracket of FIG. 17 taken along the plane of the outer surface of the second plate of the bracket;

FIG. 20 is a top plan view of a flat blank for the bracket of FIG. 17 prior to bending;

FIG. 21 is a bottom plan view of the bracket of FIG. 17;

FIG. 21A is a top perspective view of a vehicle frame assembly according to a further embodiment of the present invention similar to that of FIG. 13 wherein the rails are C-beams;

FIG. 21B is an enlarged perspective view of a portion of the vehicle frame assembly of FIG. 21A;

FIG. 21C is a bottom perspective view of a vehicle frame assembly according to the embodiment shown in FIG. 21A;

FIG. 21D is an enlarged perspective view of the vehicle frame assembly of FIG. 21C;

FIG. 22 is a bottom perspective view of the lower side of a vehicle frame assembly according to a further embodiment of the present invention;

FIG. 23 is an enlarged perspective view of a portion of the lower side of the vehicle frame assembly of FIG. 22;

FIG. 24 is a perspective view of an additional embodiment of a bracket for use in embodiments of the vehicle frame assemblies of the invention herein as shown in the embodiment of the vehicle frame assembly in FIG. 22;

FIG. 25 is a side elevational view of the bracket of FIG. 24;

FIG. 26 is a bottom elevational view of the bracket of FIG. 24;

FIG. 27 is a top plan view of a blank for forming the bracket of FIG. 24;

FIG. 28 is a first elevational view of the bracket of FIG. 24;

FIG. 29 is a perspective view of a fastener for use in assembling a vehicle frame assembly according to the present invention;

FIG. 30 is a perspective view of another embodiment of a fastener for use in assembling a vehicle frame assembly according to the present invention;

FIG. 31 is a top perspective view of an upper side of an additional embodiment of a vehicle frame assembly of the present invention;

FIG. 32 is an enlarged perspective view of a portion of an upper side of the vehicle frame assembly of FIG. 31;

FIG. 33 is a perspective view of a rail of the vehicle frame assembly of FIG. 31;

FIG. 34 is a side elevational view of the rail of FIG. 33;

FIG. 35 is an enlarged elevational view of a portion of the rail of FIG. 34;

FIG. 36 is an end elevational view of the rail of FIG. 34;

FIG. 37 is a perspective view of a crossmember of the vehicle frame assembly of FIG. 31;

FIG. 38 is a side elevational view of the crossmember of FIG. 37;

FIG. 39 is an end elevational view of the crossmember of FIG. 38;

FIG. 40 is a top plan view of a further embodiment of a bracket for use in embodiments of the vehicle frame assemblies of the invention herein as shown in the embodiment of the vehicle frame assembly in FIG. 31; and

FIG. 41 is a side elevational view of the bracket of FIG. 40.

### DETAILED DESCRIPTION OF THE INVENTION

The present application relates to galvanized vehicle frame assemblies. The vehicle frame assemblies may be, for example, truck or trailer frame assemblies that are configured to support a portion of a vehicle or a trailer. The vehicle frame assemblies include components joined by brackets and fasteners so that welding is not required. As a result, the vehicle frame assemblies of the present invention can be assembled by general laborers, rather than by highly skilled welders. Further, the present invention has the advantage that the mechanical fasteners used to connect the vehicle frame assembly components have a known engineering strength, whereas the mechanical strength of a weld is not readily known and may vary from one welded connection to another. The present invention allows for galvanization of the components of the vehicle frame assembly prior to assembly of the vehicle frame assembly, which allows galvanization to be accomplished more easily and with less expense. Further, the galvanized vehicle frame components can be transported separately and assembled at a desired location where they may be galvanized more efficiently than most prior art systems generally known.

Galvanization can be accomplished by any means known in the art, and the present invention is not limited by the specific method by which the vehicle frame assembly components are galvanized. While the present application refers generally to “galvanization” or “galvanized coatings,” it is understood that the components of the vehicle frame assembly of the present invention can receive additional or alternate surface treatments prior to assembly of the vehicle frame assembly, such as primers, paints, or other coatings to inhibit corrosion and/or wear, or which provide improved surface properties or a desired aesthetic appearance.

The brackets of the present invention provide the vehicle frame assembly with additional strength and stability relative to other methods of joining vehicle frame assembly components. The brackets facilitate connection of the rails and crossmembers and facilitate proper positioning of the preferably pre-galvanized vehicle frame assembly components. Further, the use of brackets allows for connection of vehicle frame assembly components composed of different materials, such as aluminum and steel, which cannot generally be joined via welding.

The present application in some embodiments will be described using words such as “upper” and “lower,” “inner” and “outer,” “right” and “left,” “interior” and “exterior,” and the like. These words and words of similar directional import are used for assisting in the understanding of the invention when referring to the drawings or another component of the invention and, absent a specific definition or meaning otherwise given by the specification, such terms should not be considered limiting to the scope of the invention.

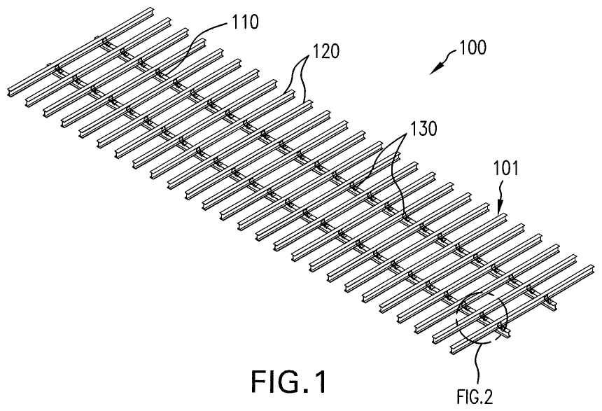

Referring now to FIGS. 1-12, there is shown one embodiment of a vehicle frame assembly according to the present invention. The embodiment of the present invention is shown is referred to generally herein as assembly 100. The vehicle frame assembly 100 includes at least one rail 110 and a plurality of crossmembers 120. As shown, there are two rails 110. The rails 110 and crossmembers 120 are preferably pre-galvanized. Galvanization or application of other types of coatings to the rails 110 and crossmembers 120 is preferably performed prior to assembly of the vehicle frame assembly 100, but in alternate embodiments may be applied after assembly of the vehicle frame assembly 100 if desired.

The rails 110 are arranged generally longitudinally, and the crossmembers 120 are arranged generally transversely to the rails 110. Preferably, the crossmembers 120 are positioned substantially perpendicularly to the rails 110. When two or more rails 110 are present (as shown) the rails 110 are arranged substantially parallel to one another and are spaced apart. It should be understood based on the disclosure that just one, two, or three or more rails 110 may be used depending on the size or requirements for use of the assembly 100. Similarly, the crossmembers 120 are preferably arranged so that they are substantially parallel to one another and are also spaced apart.

The rails 110 are preferably arranged in a first plane and the crossmembers 120 are arranged in a second plane that is substantially parallel to the first plane. In a preferred embodiment, the second plane in which the crossmembers 120 are arranged is elevated above the first plane so that the crossmembers 120 are stacked on the rails 110. However, in an alternate embodiment, the second plane may be positioned beneath the first plane so that the rails 110 are positioned on top of the crossmembers 120. The number of crossmembers may also be varied as would be understood by one skilled in the art based on this disclosure, so as to allow for different load support and/or depending on the length and requirements of the frame design.

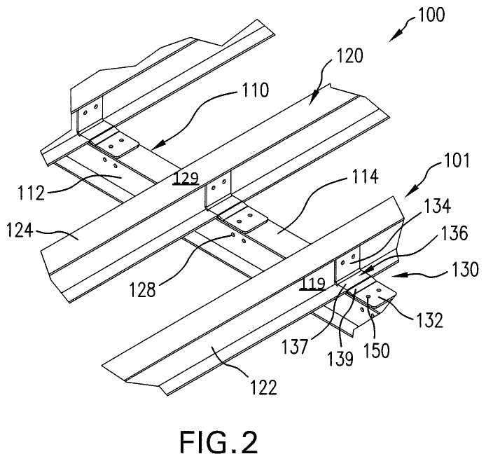

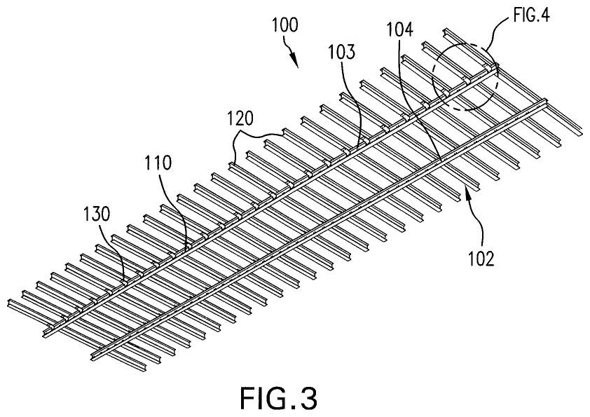

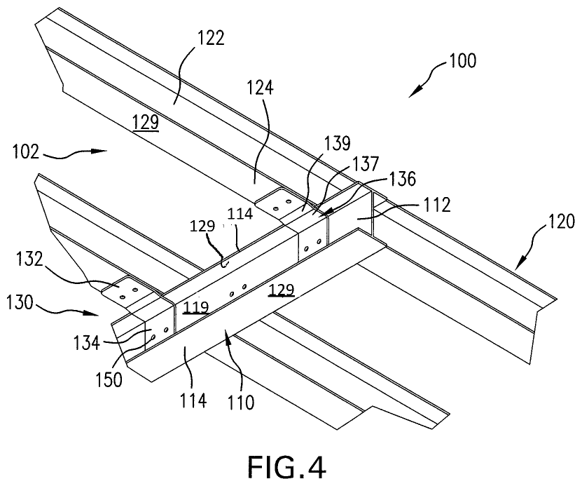

Brackets 130 are used to connect the rails 110 and crossmembers 120 without damaging the galvanized coatings of the rails 110 and crossmembers 120. The brackets 130 may be positioned on an upper side 101 of the vehicle frame assembly 100 as shown in FIGS. 1-2 and/or on a lower side 102 of the vehicle frame assembly 100 as shown in FIGS. 3-4. Multiple brackets 130 may be used to connect a crossmember 120 to a rail 110 to provide the connection with additional strength. The brackets 130 are themselves preferably also galvanized so that all components of the vehicle frame assembly 100 are galvanized.

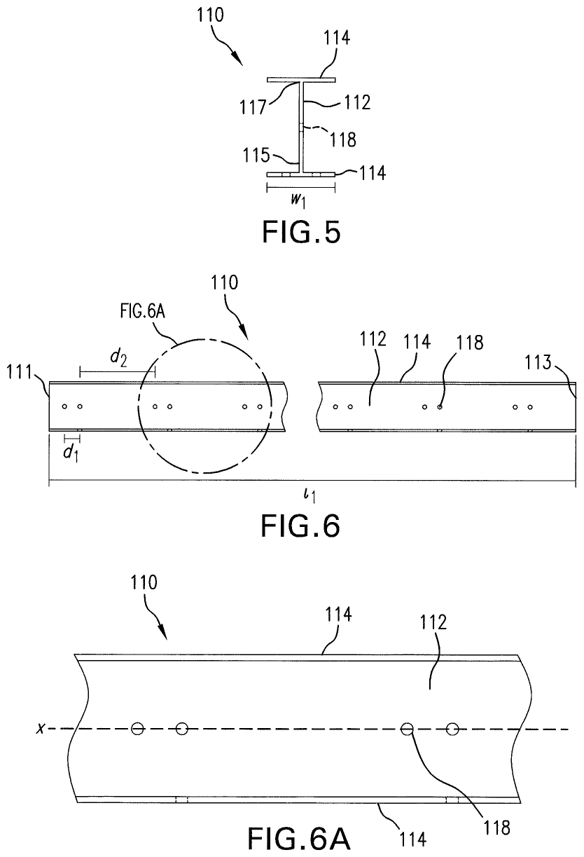

Referring now to FIGS. 5-7A, there are shown views of a rail for use in the vehicle frame assembly of FIG. 1. The rail 110 is shown in a preferred embodiment as an I-beam and the rail 110 is preferably substantially linear in configuration. However, the rail 110 may also be formed from fabricated metal sections and may be configured as a hollow or solid square in cross sectional configuration and more preferably as a beam, such as a C-beam, a T-beam, or an I-beam (as shown in FIGS. 1-12), among other types of beams known in the art. Further, the rail 110 is preferably formed from a metal, such as steel or aluminum.

In one embodiment as shown in FIG. 5, the rail 110 is an I-beam having a vertically arranged web 112 with a first end 115 and a second end 117, and a horizontally arranged flange 114 on each of the first end 115 and second end 117. The rail 110 has a length, l₁, measured along a longitudinal axis X of the rail 110 from a first terminal end 111 to a second terminal end 113, and the length, l₁, is greater than the width, w₁, of the rail, the width being measured in a direction perpendicular to the longitudinal axis X of the rail 110 along the flange 114. When two rails 110 are present, the rails 110 may be the same type of beam or may be different types of beams. In the embodiment shown in FIGS. 1-12, two rails 110 are present and are each I-beams.

The web 112 of the rail 110 may have one or more apertures 118 for receiving a fastener. The apertures 118 are preferably arranged at intervals along the length of the rail 110. In the illustrated embodiment, as best shown in FIG. 6, the web 112 includes pairs of apertures 118 that are horizontally aligned on the web 112 along the longitudinal axis X of the rail 110 and the apertures in a pair of apertures 118 are separated longitudinally by a space, d₁. Preferably, d₁ is about 0.5 to about 1.5 inches. Further, each pair of apertures 118 is separated longitudinally from a successive pair of apertures by a space, d₂, along the longitudinal axis X of the rail 110. Preferably, d₂, is about 3 to about 10 inches. The apertures 118 of the web 112 of the rail 110 are configured to be aligned with apertures of a bracket of the vehicle frame assembly 100 so that fasteners can be inserted through the aligned apertures. The apertures facilitate placement of brackets on the web 112 of the rail 110 and securement of the brackets to the rail 110 without the use of welding, as welding may damage the galvanized coating of the rail 110.

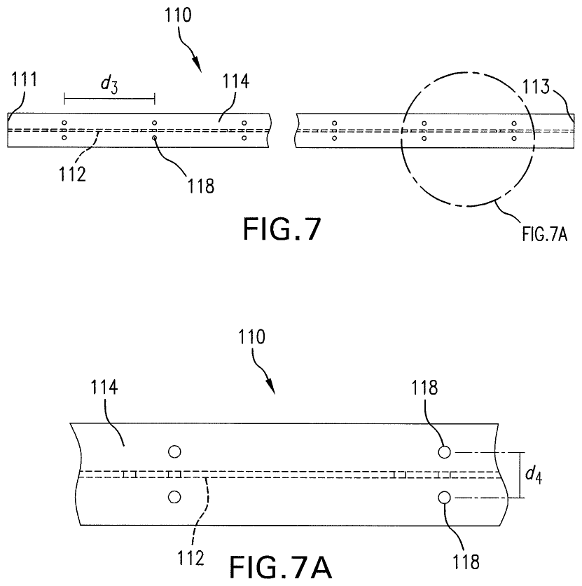

The rail 110 may also include apertures 118 on either of the top or bottom flanges 114 of the rail 110. Preferably, as shown, for example, in FIGS. 7 and 7A, the apertures 118 are on a flange 114 of the rail 110. In FIGS. 7 and 7A, preferably, pairs of apertures 118 are arranged on a flange 114 of the rail 110, and each aperture 118 in a pair of apertures is aligned and separated by a space, d₄, in a direction perpendicular to the longitudinal axis X of the rail 110. Preferably, d₄ is about 0.5 to about 1.5 inches. Each aperture 118 of a pair of apertures on the flange 114 of a rail is positioned on the flange such that in a plan view of the flange, each aperture would lie on an opposing side of the web 112 of the rail 110. Successive pairs of apertures 118 are also spaced longitudinally from one another along the rail 110 at an interval, d₃. Preferably, d₃ is about 3 to about 10 inches. The apertures 118 on the flange 114 are also configured to align with apertures of a bracket used to connect the rail 110 to a crossmember.

In determining the size and spacing of the apertures on the rail so as to align with apertures in an associated bracket as described further below, one skilled in the art would understand based on this disclosure that the locations of such apertures and their spacing longitudinally on the web of the rail as well as transversely on any or both flange(s) of the rails can be varied to accommodate a particular frame assembly design and to provide adequate strength and support for the particular frame design and intended end use. Thus, more than two apertures, differing spacing and/or different size apertures may be used in a frame assembly rail without departing from the spirit or scope of the invention.

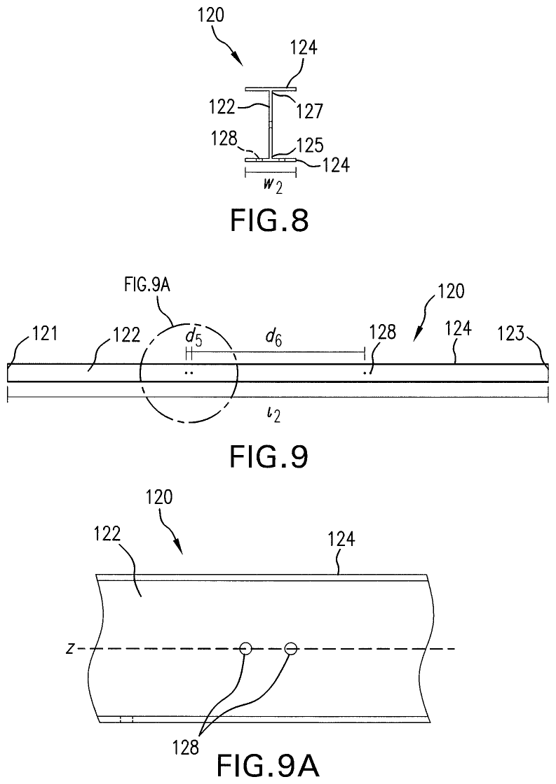

Referring now to FIGS. 8-10A, there are shown views of a crossmember for use in the vehicle frame assembly of FIG. 1. The crossmembers 120 are preferably substantially linear, and are preferably entirely linear. The crossmember 120 may be formed from fabricated metal sections and may have a hollow or solid square in cross sectional configuration and more preferably is a beam, such as a C-beam, a T-beam, or an I-beam as shown, among other types of beams known in the art. Further, the crossmembers 120 are preferably formed from a metal, such as steel or aluminum.

As shown in FIG. 8, the crossmembers 120 are each I-beams having a vertically arranged web 122 with a first end 125 and a second end 127, and horizontally arranged flanges 124 on the first end 125 and second end 127 of the web 122. While crossmembers 120 may vary in size and shape, each crossmember 120 preferably has substantially the same shape and dimensions. The crossmembers 120 have a length, l₂, measured along a longitudinal axis Z of the crossmember 120 that is greater than the width, w₂, of the crossmember 120, the width being measured in a direction perpendicular to the longitudinal axis Z of the crossmember 120 along the flange 124.

The web 122 of the crossmember 120 may have one or more apertures 128 for receiving fasteners, as shown in FIGS. 9 and 9A. The apertures 128 are preferably arranged in pairs that are aligned along the longitudinal axis Z of the crossmember 120 and the apertures in a pair of apertures are separated longitudinally by a space, d₅. Preferably, d₅ is about 0.5 to about 1.5 inches. Further, successive pairs of apertures 128 are spaced longitudinally along the length of the crossmember 120 by a space, d₆. Preferably, d₆ is about 25 to about 35 inches. The apertures 128 on the web 122 of the crossmember 120 are configured to be aligned with apertures on a bracket of the vehicle frame assembly 100 so that a fastener can be inserted through the aligned apertures to secure the bracket to the crossmember 120. Thus, the apertures 128 on the crossmembers 120 facilitate placement of brackets on the crossmember 120 and securement of the brackets to the crossmembers 120 without the use of welding, which may damage the galvanized coating of the crossmembers 120.

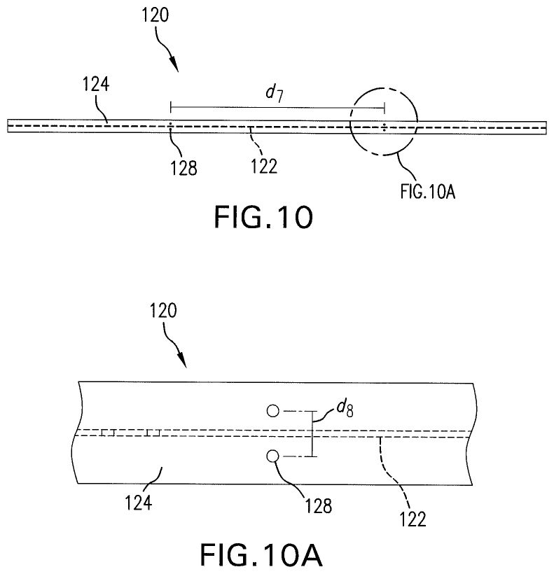

One or both of the top or bottom flanges 124 of the crossmembers 120 may also include apertures 128. Preferably, apertures 128 are on the flange 124 of the crossmember 120 that is opposite that of the rail, i.e., if the apertures in the rail are on the top flange, the apertures on the crossmember are on the bottom flange as shown as shown, for example, in FIGS. 10 and 10A, or vice versa. The apertures 128 on the flange 124 are arranged in pairs that are aligned in a direction transverse to the longitudinal axis Z of the crossmember 120. Each aperture 128 of the pair of apertures is arranged such that when viewed in a plan view, they are preferably positioned so as to lie on opposing sides of the web 122 of the crossmember 120 and the apertures 128 in the pair are separated by a space, d₈. Preferably, d₈ is about 0.5 to about 1.5 inches. Further, successive pairs of apertures 128 are preferably spaced apart longitudinally at an interval, d₇, along the longitudinal axis of the crossmember 120. Preferably, d₇ is about 34 to 42 inches.

As with the rails, in determining the size and spacing of the apertures on the crossmembers so as to align with apertures in an associated bracket, one skilled in the art would understand based on this disclosure that the locations of such apertures and their spacing longitudinally on each web of a crossmember as well as transversely on any or both flange(s) of a crossmember can be varied to accommodate a particular frame assembly design and to provide adequate strength and support for the particular frame design and intended end use as well as to align with the particular brackets chosen. Thus, more than two apertures, differing spacing and/or different size apertures may be used in a frame assembly crossmember without departing from the spirit or scope of the invention.

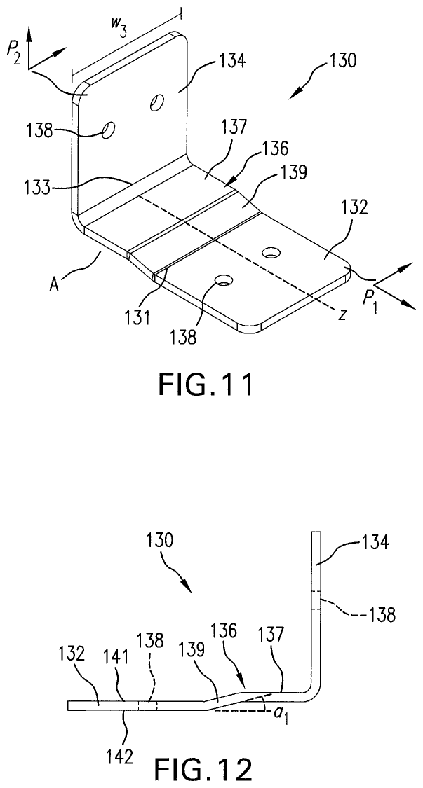

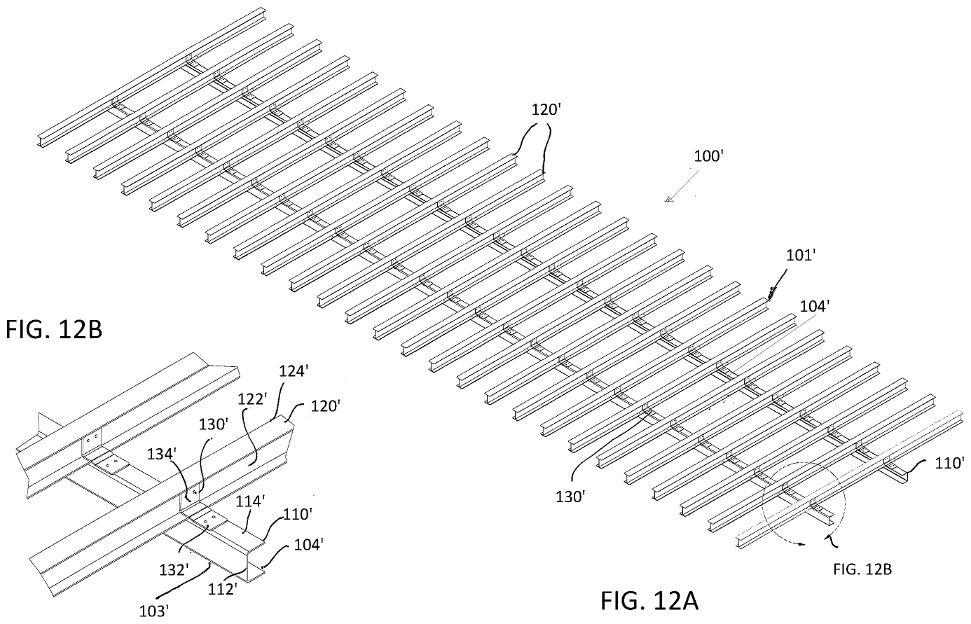

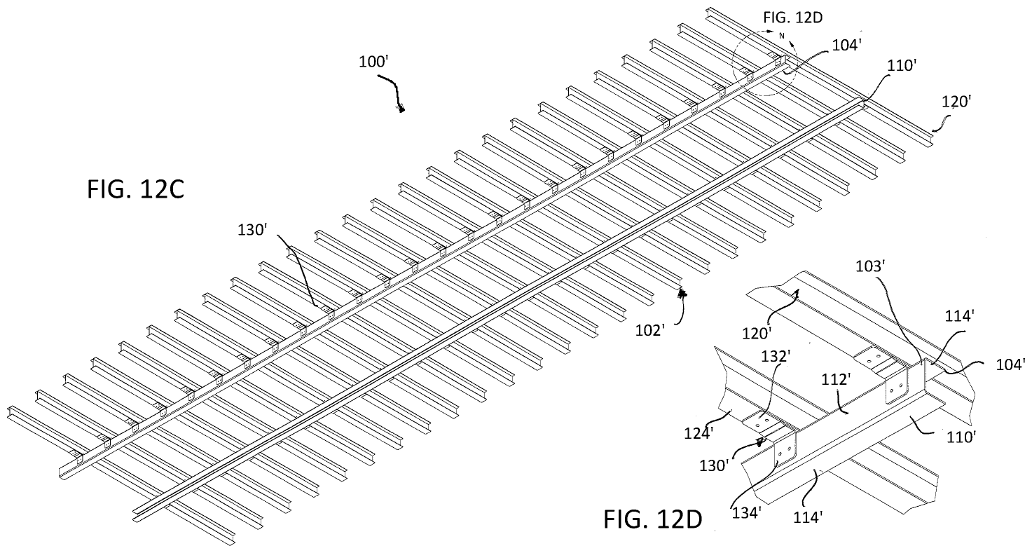

Referring now to FIGS. 11-12, an embodiment of a bracket useful in the vehicle frame assembly of FIG. 1 is shown. It should be understood that the combination of brackets, rails and crossmembers shown herein may be varied based on this disclosure. In the illustrated, embodiment of FIGS. 1-12, the bracket 130 includes a first plate 132 and a second plate 134 connected by a connection section 136. As used herein “first plate” and “second plate” are used as differentiators to assist the reader in evaluating the particular bracket being described below.

The first plate 132 is arranged in a first plane, P₁, that is perpendicular to a second plane, P₂, in which the second plate 134 is arranged, and the first plate 132 and the second plate 134 are preferably always spaced somewhat apart. The connection section 136 extends between and connects an interior end 131 of the first plate 132 and an interior end 133 of the second plate 134. In the illustrated embodiment, the bracket 130 has a width, w₃, measured transversely across the bracket along a direction that is transverse to the longitudinal axis Z of the bracket 130.

The bracket 130 is preferably formed from metal, such as aluminum or steel, and may alternately be composed of a composite material. The bracket 130 may be galvanized and/or coated to inhibit corrosion and wear, to improve surface properties, and to provide a desired aesthetic appearance. The bracket 130 may be of unitary construction, and may be formed by bending a blank formed from a sheet or plate into the desired configuration. However, the present invention is not limited by the specific method of forming the bracket and the brackets may be alternatively be formed via molding.

The connection section 136 bridges an area, A, defined between the first plate 132 and the second plate 134 of the bracket 130. The connection section 136 includes a first portion 139 adjacent to the first plate 132 and a second portion 137 adjacent to the second plate 134. The second portion 137 is substantially parallel to the first plate 132 but is arranged in a plane separate from, and in the embodiment shown above, the plane P₁ of the first plate 132. Accordingly, the first portion 139 of the connection section 136 has a slope or otherwise extends between the second portion 137 of the connection section 136 and the first plate 132 to bridge the separation of the second portion 137 and the plane P₁ of the first plate. As shown in FIG. 11, the first portion 139 slopes downwardly from the second portion 137 of the connection section 136 to the first plate 132 at an incline. In this manner, the first portion 139 spans the difference in elevation between the first plate 132 and the second portion 137 of the connection section 136. The sloped second portion 137 facilitates manufacturing of the bracket 130 via the bending of a blank while also providing stability in the connection between a rail and a crossmember.

In an alternate embodiment (not shown) rather than being inclined or sloped, the first portion 139 may be substantially perpendicular to the second portion 137 of the connection section 136. A perpendicular first portion 139 may allow the bracket 130 to fit more closely to a flange of a rail or crossmember to which the bracket is connected depending on the design and thickness of the rail or crossmember. As shown, the first portion 139 of the connection section 136 forms an angle a₁ with a plane P₁ of the first plate 132 of about 10 degrees to about 90 degrees. The angle a₁ may be varied depending upon the configuration of the rail 110 and crossmembers 120. In operation, the second portion 137 of the connection section 136 is preferably configured to be in at least partial facing engagement with a flange of a crossmember 120 or rail 110 to which the second plate 134 of the bracket 130 is connected via the web of a corresponding crossmember or rail, while the first portion 139 of the connection section 136 slopes downwardly from the second portion 137 to allow the first plate 134 to attach to a flange of the opposite, connected rail 110 or crossmember 120 depending on whether the bracket 130 is installed on the upper or lower side 101, 102 of the assembly 100. The connection section 136 helps to provide additional support and stability to the connection of the rail 110 and crossmember 120.

The first plate 132 and the second plate 134 of the bracket 130 may each define one or more apertures 138 extending through the first and second plates 132, 134 from a first surface 141 to an opposing surface 142 thereof. In the illustrated embodiment, the first plate 132 defines a pair of apertures 138 that are aligned in a direction transverse to a longitudinal axis Z of the bracket 130, as shown in FIG. 11. Similarly, the second plate 134 includes a pair of apertures 138 that are aligned in a direction transverse to the longitudinal axis Z of the bracket 130. In alternate embodiments of the bracket 130, the first and second plates 132, 134 may have fewer or additional apertures 138 which may be variously arranged on the first and second plates 132, 134. The apertures 138 are shown as having a generally circular shape and each aperture 138 preferably has substantially the same or the same shape and dimensions. The apertures 138 are configured to receive a fastener for securing the bracket 130 to a rail or crossmember. Additional apertures 138 may be included in order to provide a stronger or more stable connection, or to provide options as to which apertures to align with the corresponding apertures on a rail 110 or crossmember. The aperture size may be varied so as to correspond to apertures in the rails and crossmembers as well as to accommodate a desired fastener(s) to be used in the frame assembly.

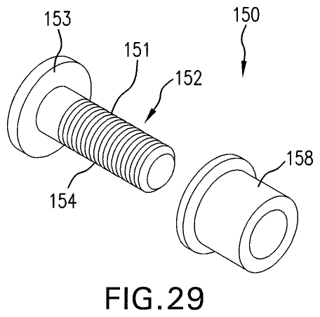

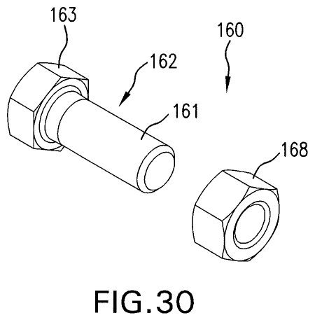

While any of various fasteners may be used to secure the bracket 130 to the rail 110 or crossmember 120, such as bolts, pins, rivets, threaded rods and the like, the fastener is preferably a swaged-on lock bolt, such as for example, a HuckBolt®. Preferred types of fasteners for use with the vehicle frame assemblies of the present invention are shown in FIGS. 29-30. In FIG. 29, the fastener 150 is a lock bolt having a bolt portion 152 with a head 153 and a rod 151. The rod 151 has threads 154 for receiving a locking portion 158 on the rod 151. The locking portion 158 is shown as having a generally cylindrical shape. In FIG. 30, the fastener 160 is also a lock bolt having a bolt portion 162 with a head 163 and rod 161. The rod 161 is not threaded and is configured to receive a locking portion 168. The locking portion 168 has a hexagonal shape. In use, the rod 151, 161 of the fastener 150, 160 can be inserted through the aligned apertures of the bracket 130 and rail 110 or crossmember 120, and the locking portion 158, 168 can be installed on the rod 151, 161 to secure the bracket 130 to the rail 110 or crossmember 120.

To connect a rail 110 to a crossmember 120, a bracket, such as bracket 130 can be positioned on an upper side 101 of the vehicle frame assembly 100, as shown in FIG. 2. The first plate 132 of the bracket 130 is configured to engage a surface of the rail 110 and the second plate 134 is configured to engage a surface of the crossmember 120. The first and second plates 132, 134 may be in facing engagement with the surfaces of the rail 110 and crossmember 120, respectively or may be separated therefrom, such as by a gasket or spacer in order to reduce frictional contact and to prevent damage to the galvanized coating of the rail 110 and crossmember 120. In the configuration shown in FIG. 2 with cross members on top of the rails, the first plate 132 of the bracket 130 engages a flange 114 of the rail 110 and the second plate 134 is configured to engage a web 122 of the crossmember 120. The first plate 132 is positioned on the flange 114 of the rail 110 and adjacent to a flange 124 of the crossmember 120 to which the second plate 134 of the bracket 130 is connected so that the connection section 136 of the bracket 130 connects the first and second plates 132, 134 and extends over the lower flange 124 of the crossmember 122. A second portion 137 of the connection section 136 may be in facing engagement with the flange 124 of the crossmember 120 to which the second plate 134 of the bracket 130 is connected, and the first portion 139 of the connection section 136 slopes toward the first plate 132 of the bracket 130 positioned on the flange 124 of rail 110 or crossmember 120 to which it is attached. In this way, the bracket 130 generally contours to the shape of the crossmember 120 and fits closely against the rail 110 and crossmember 120 so as to facilitate proper alignment of the rail 110 and crossmember 120.

The first and second plates 132, 134 are secured to the surfaces of the rail 110 and crossmember 120 by fasteners as discussed above. In embodiments of the bracket 130 having apertures, as shown for example in FIG. 2, the apertures of the first plate 132 are situated to sit in alignment with apertures of the upper flange of the rail 110 so that a fastener can be inserted through the aligned apertures to secure the first plate 132 to the upper flange 114 of the rail 110. Similarly, the apertures of the second plate 134 of the bracket 130 are situated to sit in alignment with the apertures on the web 122 of the crossmember 120 so that a fastener 150 can be inserted through the aligned apertures. Thus, the brackets 130 are preferably configured so that the apertures of the bracket 130 align with the apertures of the rail 110 and crossmember 120 selected. In alternate embodiments in which the brackets 130 do not have apertures, the first and second plates 132, 134 may be secured to the surfaces of the rail and crossmembers such as by the use of adhesives or welding. Further, rivets can be driven through the first or second plate 132, 134 of the bracket 130 and through the web or flange of the rail 110 or crossmember 120 to which the first or second plate 132, 134 is to be connected.

The brackets 130 can additionally or alternatively be positioned on a lower side 102 of the vehicle frame assembly 100 as shown, for example, in FIGS. 3-4. On the lower side 102 of the vehicle frame assembly 100, the brackets 130 are positioned in a similar manner as those on the upper side 101 of the assembly 100, but the first plate 132 of each bracket 130 is configured to engage a flange surface 129 of a lower flange 124 of the crossmember 120 and the second plate 134 is configured to engage a surface 119 of the web 112 of the rail 110. Specifically, the first plate 132 of the bracket 130 is connected with a flange 124 of the crossmember 120 and the second plate 134 is connected to a web 112 of the rail 110. The first plate 132 and second plate 134 are preferably in facing engagement with the flange 124 and web 112, respectively, or may be spaced therefrom, such as with a gasket or spacer as discussed above. The connection section 136 extends over the upper flange 114 of the rail 110 so that the second portion 137 of the connection section 136 is in facing engagement with the upper flange of the rail and the same rail to which the second plate 134 of the bracket 130 is connected via the web 112 of the rail. As noted, a portion of the connection section 136 is preferably in facing engagement with the upper flange 114 of the rail 110 to which the second plate 134 of the bracket 130 is connected. The first and second plates 132, 134 of the bracket 130 can be secured to the rail 110 and crossmember 120 using fasteners or via fastening methods as described above. While the brackets 130 are shown as being positioned on an outer side 103 of the rails 110 facing the exterior of the assembly 100, brackets 130 can alternatively or additionally be installed on the opposing, interior side 104 of the rails 110.

As noted above, the embodiment of FIGS. 1-12 including the exemplary brackets 130 are illustrated on a frame including I-beams as both rails and cross members. FIGS. 12A through 12D provide a variation on the embodiment of FIGS. 1-12, referred to herein as embodiment 100′, wherein like parts have like numbers for the purpose of illustrating the variation, and wherein the rails 110′ are illustrated as C-beams. As with the embodiment of FIGS. 1-12, the same design of bracket 130′ is used as brackets 130. FIGS. 12A and 12B show a frame assembly having C-beams as rails 110′ and brackets 130′ on the upper side 101′ of the frame assembly 100′. The C-beams include flanges 114′ and an extending web 112′ that connects the flanges 114′ on the same side. As shown, the flanges 114′ are connected on the exterior facing side 103′ of the rail 110′ with the open interior facing side 104′ of the C-beam positioned to face inwardly. The bracket 130′ is positioned so that its first plate 132′ is connected to the upper flange 114′ of the rail 110′ and its second plate 134′ is connected to the web 122′ of the I-beam crossmember 120′.

In FIGS. 12C and 12D as similar configuration is shown, but with the brackets attached on the bottom side 102′ of the frame assembly 100′. As shown best in FIG. 12D, the C-beam rail 110′ has a web 112′ extending between the flanges 114′ of the rail 110′ on the exterior facing side 103′ of the rail 110′ and the open side of the C-beam on the interior facing side 104′ of the rail 110′. In this configuration, the first plate 132′ of the bracket 130′ is connected to a lower flange 124′ of I-beam crossmember 120′ and the second plate 134′ is connected to the web 112′ of the C-beam rail 110′.

FIGS. 12A-12D illustrate how the embodiment of FIGS. 1-12 can be employed when the type of rail (or crossmember) is changed while still achieving the same strength and structure for the overall frame assembly.

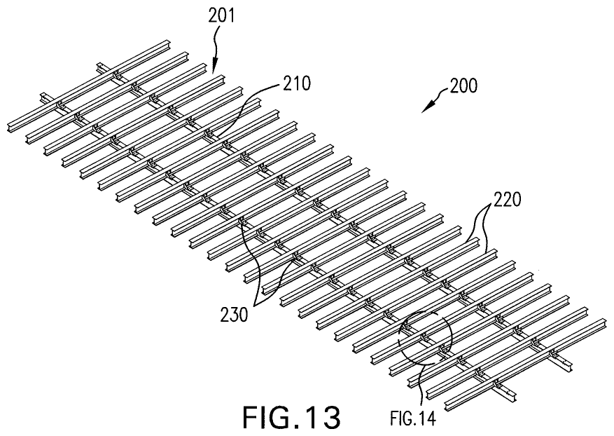

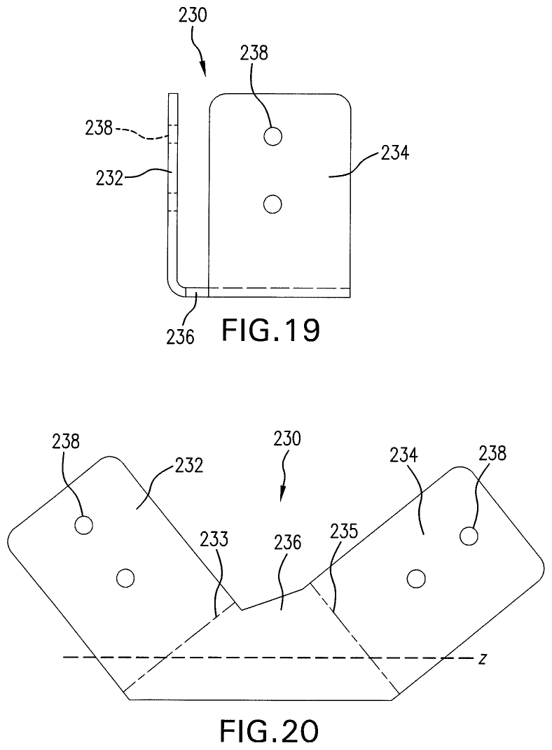

Referring now to FIGS. 13-21, there is shown a further embodiment of a vehicle frame assembly according to the present invention, generally referred to herein as assembly 200. The vehicle frame assembly 200 of FIG. 13 is substantially the same as the vehicle frame assembly of FIG. 1 with the exception of the brackets employed. The rail 210 and crossmembers 220 may be configured and arranged in the same manner as discussed above with respect to the embodiment of FIG. 1 provided all apertures of the relevant portion of the rails, crossmembers and brackets are in substantial alignment.

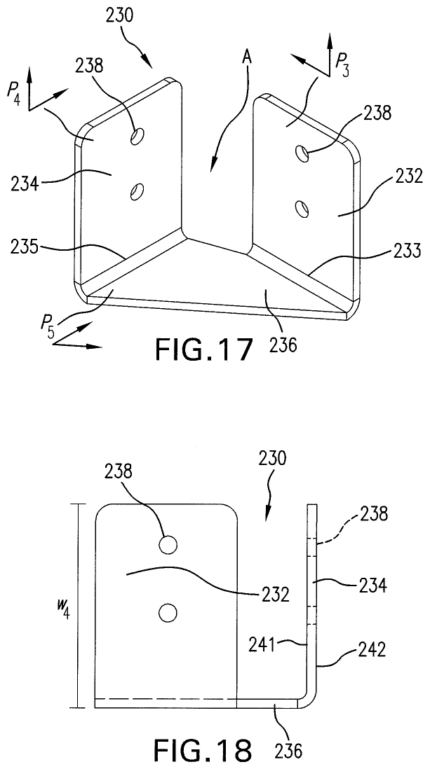

The bracket 230, similar to the bracket 130 of FIGS. 11-12, is used to connect the rail 210 to the crossmembers 220. The bracket 230 as best shown in FIGS. 17-21 includes a first plate 232, a second plate 234 and a connection section 236 that connects the first plate 232 and the second plate 234. The first plate 232 is arranged in a plane, P₃, that is substantially perpendicular to a plane, P₄, in which the second plate 234 is arranged, and the first plate 232 and second plate 234 are preferably spaced apart. In the illustrated embodiment, the first plate and second plate 232, 234 each have a width w₄ that is the same or substantially the same, wherein the width w₄ is measured when the bracket is formed in a direction perpendicular to the longitudinal axis Z that extends longitudinally along the plane P₅ of connection section 236. The connection section 236 connects an interior bend 233 of a first plate 232 to an interior bend 235 of the second plate 234 and bridges an area A between the first and second plates 232, 234. The connection section 236 is in a plane, P₅, which is perpendicular to the plane P₃ of the first plate 232 and plane P₄ of the second plate 234. The connection section 236 is preferably substantially planar.

The bracket 230 is preferably formed from metal, such as aluminum or steel, or may be formed from a composite material. The bracket 230 may be galvanized and/or coated to inhibit corrosion and wear, to improve surface properties, and to provide a desired aesthetic appearance. The bracket 230 may be of unitary construction and may be formed by bending a blank (see, e.g., FIG. 20) formed from a sheet or plate into the desired configuration. However, the present invention is not limited by the specific method of forming the bracket and may be formed by molding.

The first plate 232 and the second plate 234 of the bracket 230 may each define apertures 238 extending through the bracket 230 from a first surface 241 of the bracket 230 to an opposing surface 242 of the bracket 230. The apertures 238 are configured to receive a fastener of the type discussed above for securing the first and second plates 232, 234 of the bracket 230 to a rail or crossmember. In the illustrated embodiment, the first plate 232 and second plate 234 each have a pair of apertures 238 aligned when the bracket is formed as in FIG. 17 in a direction transverse to the longitudinal axis Z of the bracket 230 and to plane P₅, as shown in FIG. 17. In this way, the apertures 238 of the first plate 232 can be aligned with apertures on a flange of a rail or crossmember. The apertures 238 are each generally circular and have the same dimensions, and as with the embodiment 100, can be varied in size and placement, as can the apertures on crossmembers and rails to correspond for varying configurations. In alternate embodiments, the first and second plates 232, 234 can have fewer or additional apertures which may be arranged in any of various patterns or configurations. The use of additional apertures, and thus fasteners, may be necessary to provide a more stable connection, or the additional apertures may provide options for which apertures to align with apertures of a rail or crossmember. Any of the fasteners as discussed above with respect to the vehicle frame assembly 100 and bracket 130 may be used with brackets 230 and the assembly 200.

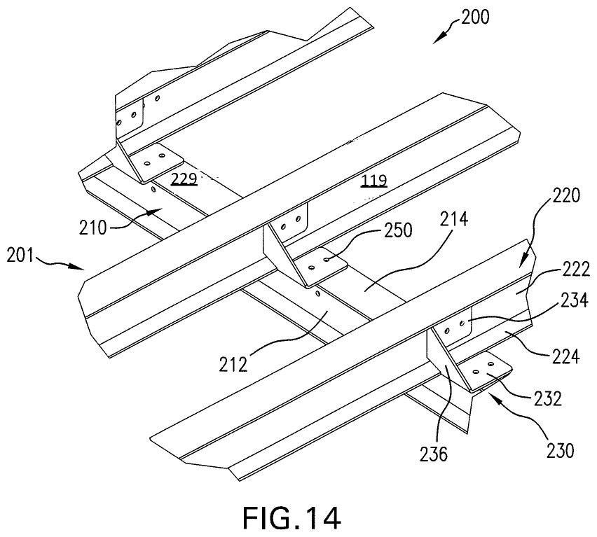

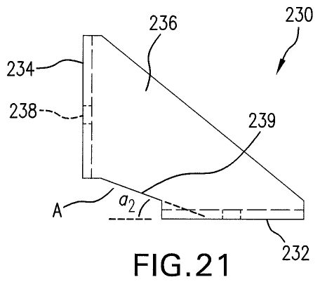

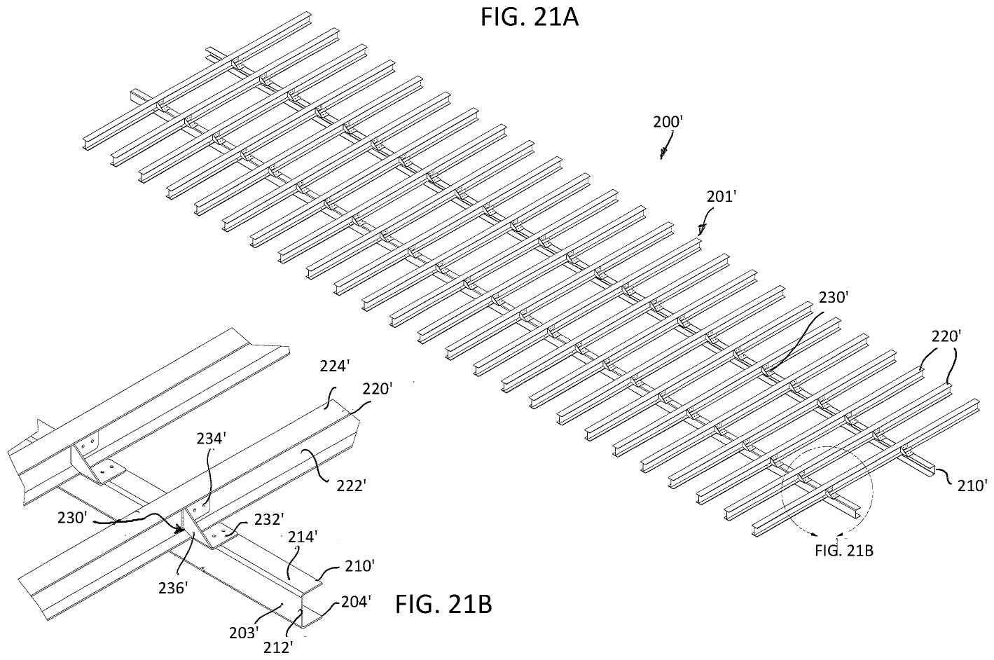

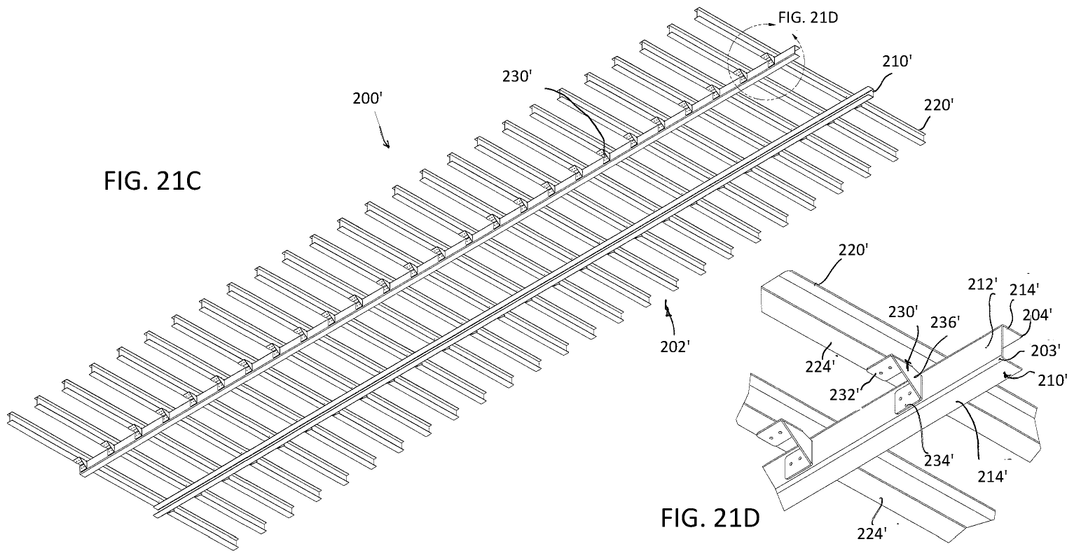

Referring now to FIGS. 13-14, there is shown an upper side 201 of the vehicle frame assembly 200. The first plate 232 of the bracket 230 is configured to engage a flange surface 229 of a flange 214 of a rail 210 and the second plate 234 of the bracket 230 is configured to engage a web surface 219 of a crossmember 220. Preferably, the first plate 232 is connected to an upper flange 214 of the rail 210 and the second plate 234 is preferably connected to a web 222 of the crossmember 220. The first plate 232 and second plate 234 may be in facing engagement with the respective flange 214 and web 222, or may be separated therefrom by a gasket or spacer. The connection section 236 extends over a lower flange 224 of the crossmember 220 to which the second plate 234 is connected and bridges the area A between the first and second plates 232, 234. The connection section 236 may be in at least partial facing engagement with the flange 224 of the crossmember 220 to which the second plate 234 is connected. Thus, with the second plate 234 connected to a web 222 of the crossmember 220, the connection section 236 is shown as being angled downwardly to connect to the first plate 232. As best shown in FIG. 21, an edge 239 of the connection section 236 forms an angle, a₂, with respect to a plane P₃ of the first plate 232 that may be about 10 degrees to about 90 degrees. The angle, a₂, may be selected as necessary for the connection section 236 to bridge the area A between the first and second plates 232, 234. Further, when the bracket 230 is installed on the vehicle frame assembly 200, the connection section 236 of the bracket 230 is substantially perpendicular, or fully perpendicular, to the web surface 219 of the web 222 of the crossmember 220 and serves a bracing or reinforcing function for the crossmembers 220 in order to provide the vehicle frame assembly 200 with additional support and stability.

The first and second plates 232, 234 can be secured to the surfaces of the rail 210 and crossmember 220 by fasteners or fastening methods as described above with respect to assembly 100. Thus, the first and second plates 232, 234 may be secured to the rail 210 and crossmember 220 via as rivets, bolts, or threaded rods, among others. In an embodiment of the bracket 230 having apertures, the apertures of the first plate 232 are situated so as to be aligned with apertures of the upper flange 214 of the rail 210 so that a fastener can be inserted through the aligned apertures. Similarly, the apertures of the second plate 232 are situated so as to be aligned with apertures on the web 222 of the crossmember 220 so that fasteners can be inserted through the aligned apertures. In alternate embodiments in which the brackets 230 do not have apertures, the first and second plates 232, 234 may be secured to the surfaces of the rail and crossmembers such as by the use of adhesives or welding. Further, rivets can be driven through the first or second plate 232, 234 of the bracket 230 and through the web or flange of the rail 210 or crossmember 220 to which the first or second plate 232, 234 is to be connected.

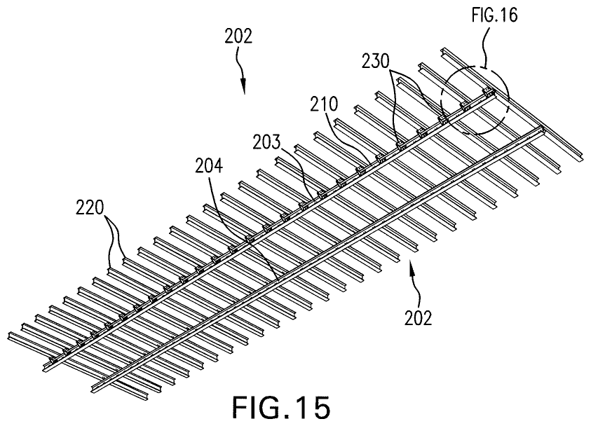

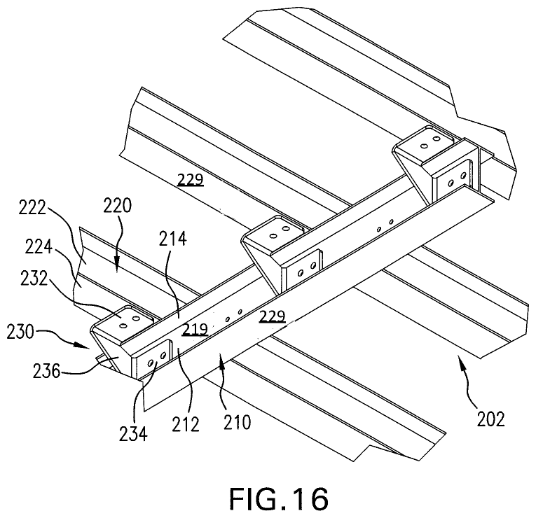

Referring now to FIGS. 15-16, there is shown a lower side 202 of the vehicle frame assembly 200 of FIG. 13. The brackets 230 may alternately or additionally be positioned on the lower side 202 of the vehicle frame assembly 200 as shown. On the lower side 202 of the vehicle frame assembly 200, each bracket 230 connects a lower flange 224 of a crossmember 220 to a web 212 of a rail 210. As more clearly shown in FIG. 16, the first plate 232 of the bracket 230 is connected to a flange 224 of a crossmember 220. The first plate 232 may be in facing engagement with the flange 224, or may be separated therefrom, such as via a gasket or spacer. The first plate 232 of the bracket 230 is also positioned so that it is adjacent to the flange 214 of the rail 210 to which the second plate 234 is connected. The second plate 234 is connected to the web 212 of the rail 210. The second plate 234 may be in facing engagement with the web 212 of the rail 210, or may be separated therefrom, such as via a gasket or spacer.

The connection section 236 extends over an upper flange 214 of the rail 210 to which the second plate 234 is connected and bridges the area A between the first and second plates 232, 234. The connection section 236 may be at least partially in facing engagement with the flange 214. While the brackets 230 are shown as being positioned on an outer or exterior facing side 203 of the rail 210 in FIG. 15, it is understood that the brackets 230 could alternatively or additionally be positioned on the opposing, interior facing side 204 of the rail 210.

As noted above, the embodiment of FIGS. 13-21 including the exemplary brackets 230 are illustrated on a frame including I-beams as both rails and cross members. FIGS. 21A through 21D provide a variation on the embodiment of FIGS. 13-21, referred to herein as embodiment 200′, wherein like parts have like numbers for the purpose of illustrating the variation, and wherein the rails 210′ are illustrated as C-beams. As with the embodiment of FIGS. 13-21, the same design of bracket 230′ is used as brackets 230. FIGS. 21A and 12B show a frame assembly having C-beams as rails 210′ and brackets 230′ on the upper side 201′ of the frame assembly 200′. The C-beams include flanges 214′ and an extending web 212′ that connects the flanges 214′ on the same side. As shown, the flanges 214′ are connected on the exterior facing side 203′ of the rail 210′ with the open interior facing side 204′ of the C-beam positioned to face inwardly. The bracket 230′ is positioned so that its first plate 232′ is connected to the upper flange 214′ of the rail 210′ and its second plate 234′ is connected to the web 222′ of the I-beam crossmember 220′.

In FIGS. 21C and 212D a similar configuration is shown, but with the brackets attached on the bottom side 202′ of the frame assembly 200′. As shown best in FIG. 21D, the C-beam rail 210′ has a web 212′ extending between the flanges 214′ of the rail 210′ on the exterior facing side 203′ of the rail 210′ and the open side of the C-beam on the interior facing side 204′ of the rail 210′. In this configuration, the first plate 232′ of the bracket 230′ is connected to a lower flange 224′ of I-beam crossmember 220′ and the second plate 234′ is connected to the web 212′ of the C-beam rail 210′.

FIGS. 21A-21D illustrate how the embodiment of FIGS. 13-21, like the embodiment of FIGS. 1-12 can be employed when the type of rail (or crossmember) is changed while still achieving the same strength and structure for the overall frame assembly.

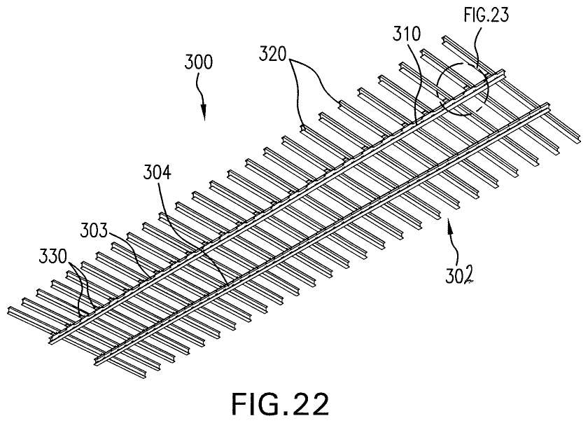

Referring now to FIGS. 22-28, there is shown an additional embodiment of the vehicle frame assembly of the present invention, generally referred to herein as assembly 300, with like reference numbers referring to corresponding components of prior embodiments herein. The vehicle frame assembly 300 is substantially the same as vehicle frame assemblies 100, 100′, 200 and 200′ and differs only with respect to the brackets 330. The rail 310 and crossmembers 320 may be configured and arranged as discussed above with respect to vehicle frame assemblies 100, 200 and may be substituted as well with a C-beam such as is shown in embodiments 100′ and 200′ or other different rail or crossmember as described elsewhere herein.

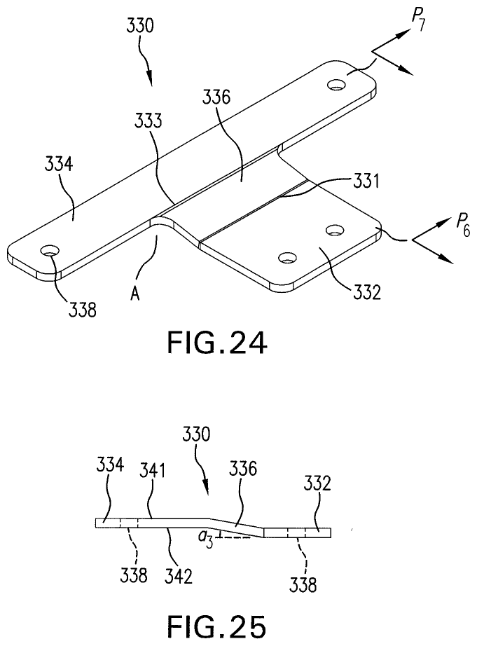

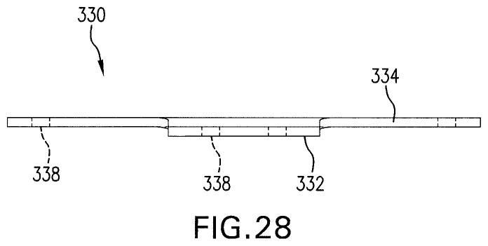

A further embodiment of a bracket 330 is shown in FIGS. 24-28 and includes a first plate 332 and a second plate 334 connected by a connection section 336. As best shown in FIG. 28, the first plate 332 is arranged in a first plane P₆ and the second plate 334 is arranged in a second plane P₇ that is substantially parallel, and preferably parallel, to the first plane P₆ and which also preferably elevated above the first plane P₆. As best shown in FIG. 24, the connection section 336 connects an interior end 331 of the first plate 332 with an interior end 333 of the second plate 334. The connection section 336 extends along the entire interior end 331 of the first plate 332 and along a portion of the interior end 333 of the second plate 334. The connection section 336 is shown as having an inclined or sloped configuration so as to form an angle, a₃, with the plane of the first plate 332. However, in an alternate embodiment, the connection section 336 may be substantially perpendicular to the first and second plates 332, 334. The angle, a₃, may be about 10 to about 90 degrees.

When the bracket 330 is installed on an upper side (not shown) of a vehicle frame assembly 300, the second plate 334 is configured so as to be connectable to a flange of a crossmember and the connection section 336 would then slope downwardly from the second plate 334 to the first plate 332 which would be connected to an upper flange of a rail 310. Thus, the connection section 336 would span the difference in elevation of the first plate 332 positioned on a flange of a rail and the second plate 334 on a flange of a crossmember. Further, the connection section 336 would bridge the area, A, between the first plate 332 and second plate 334. In this way, the bracket 330 is configured so that it generally contours to the shape of the flange of the rail and the flange of the crossmember and the bracket 330 and helps to facilitate proper alignment of the rail 310 and crossmember 320.

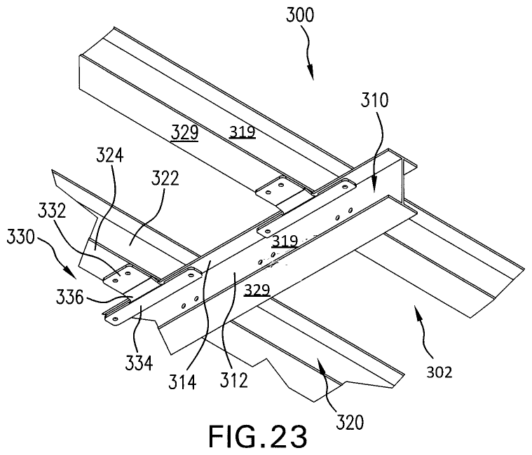

As shown in FIGS. 22-23 installation is illustrated with reference to a lower side 302 of the assembly 300. The second plate 334 of the bracket 330 is now positioned on a lower flange surface of the upper flange 314 of the rail 310. The first plate is positioned and connected on a lower flange surface 329 of a crossmember 320. The connection section 336 slopes upwardly in this installation from the second plate 334 towards the first plate 332 to span the difference in elevation between the two plates and to bridge the area A of the plate.

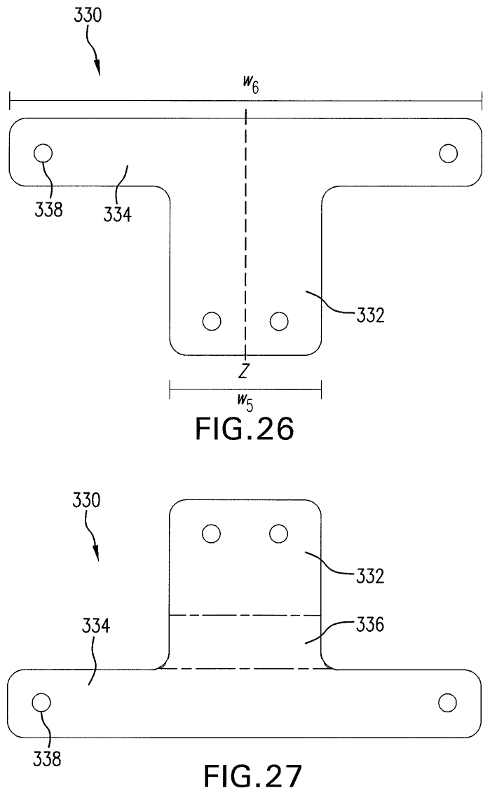

As shown in the blank for the bracket in FIG. 26-28, the bracket 330 has a longitudinal axis Z, such that the first plate 332 of the bracket 330 has a width w₅ measured in a direction transverse to the longitudinal axis Z and the second plate 334 has a width w₆ measured in a direction transverse to the longitudinal axis, wherein the width w₆ of the second plate 334 is greater than the width w₅ of the first plate 332. The width w₅ of the first plate 332 is preferably the same as or less than the width of a flange of a rail or crossmember to which the first plate 332 is to be connected so that the bracket 330 preferably does not extend beyond the edges of the flange. The width w₆ of the second plate 334 of the bracket 330 is greater than the width w₅ of the first plate 332 to facilitate securement of the second plate 334 to a flange of a rail or crossmember and for structural strength and stability.

The bracket 330 is preferably formed from metal, such as aluminum or steel, or may be formed from a composite material. The bracket 330 may be galvanized and/or coated to inhibit corrosion and wear, to improve surface properties, and to provide a desired aesthetic appearance. The bracket 330 may be of unitary construction, and may be formed by bending a blank formed from a sheet or plate into the desired configuration. However, the present invention is not limited by the specific method of forming the bracket, and the bracket may alternatively be formed via molding.

The first plate 332 and second plate 334 of the bracket 330 may each define apertures 338 which extend through the bracket 330 from a first surface 341 to an opposing surface 342 of the bracket 330. In the illustrated embodiment, the first plate 332 has a pair of apertures 338 that are aligned in a direction transverse to the longitudinal axis Z of the bracket 330. Similarly, the second plate 334 has a pair of apertures 338 that are aligned in a direction transverse to the longitudinal axis Z of the bracket 330. The apertures 338 of the second plate 334 are preferably positioned at opposing ends of the second plate 334 in a transverse direction as shown in FIG. 26 so that when the bracket 330 is installed, a fastener inserted through the apertures 338 on the second plate 334 extends through the flange of the rail or crossmember on which the second plate 334 is positioned, but the fastener does not contact the surface of the other portion of the rail or crossmember to which the first plate 332 is connected. In alternate embodiments, the first and second plates 332, 334 of the bracket 330 may have fewer or additional apertures 338 which may be arranged in various patterns. The apertures 338 are preferably circular and the same dimensions. Any of various fasteners as discussed above with respect to the vehicle frame assembly 100 and bracket 130 may be used.

The vehicle frame assembly 300 may include brackets 330 on an upper side and/or lower side thereof, as shown in FIGS. 22-23. When positioned on the lower side 302 of the vehicle frame assembly 300, the first plate 332 of the bracket 330 is configured to engage a surface 329 of the crossmember 320 and the second plate 332 is configured to engage a surface on a flange of the rail 310 as noted above. Preferably in this configuration, the first plate 332 of the bracket 330 is connected to a flange 324 of the crossmember 320 and the second plate 334 is connected to a flange 312 of the rail 310. The first plate 332 and second plate 334 may be in facing engagement with the surfaces to which they are connected, or they may be separated therefrom such as by a gasket or spacer.

The width of the first plate 332 of the bracket 330 is preferably the same as or less than the width of the flange 312 of the crossbeam 320 as shown in FIG. 23 so that the first plate 332 does not overhang the flange 324. The second plate 334 is wider than the first plate 332 and extends along the flange 312 of the rail 310 (and is also wider than the crossmember flange on which the first plate is situated), so that when a fastener is inserted through the second plate 334, the fastener contacts the flange 322 of the rail 310 but does not contact the crossmember 320.

The connection section 336 slopes from the second plate 334 towards the first plate 332 so as to span the difference in elevation. In this way, the bracket 330 fits closely to and contours to the shape of the rail 310 and crossmember 320 and helps to properly position the rail 310 and crossmember 320 and provides support and stability. The bracket 330 is shown as being positioned on an outer side 303 of the rail 310, however, the brackets 330 can alternately or additional be positioned on an, opposing interior side 304 of the rail 310.

The first and second plates 332, 334 of the brackets 330 can be secured to the surfaces of the rail 310 and crossmember 320 in the same manner as discussed above with respect to assemblies 100, 200. Thus, the first and second plates 332, 334 of the brackets 330 may be secured to respective rails 310 and crossmembers by fasteners as discussed herein. In embodiments of the bracket 330 having apertures, the apertures of the first plate 332 are aligned with apertures of the flange of the rail 310 so that a fastener can be inserted through the aligned apertures. Similarly, the apertures of the second plate 332 are aligned with apertures on the flange 322 of the crossmember 320 so that fasteners can be inserted through the aligned apertures. In alternate embodiments in which the brackets 330 do not have apertures, the first and second plates 332, 334 may be secured to the surfaces of the rail and crossmembers such as by the use of adhesives or welding. Further, rivets can be driven through the first or second plate 332, 334 of the bracket 330 and through the web or flange of the rail 310 or crossmember 320 to which the first or second plate 332, 334 is to be connected.

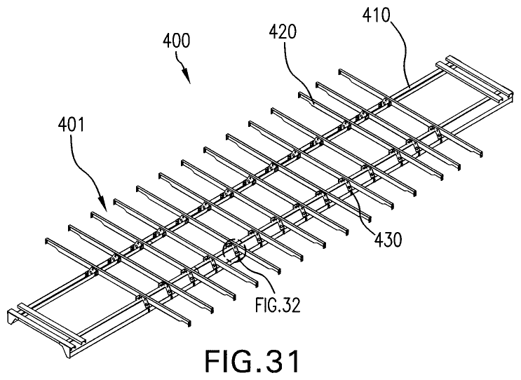

Referring now to FIGS. 31-41, there is shown another embodiment of the vehicle frame assembly according to the present invention, generally referred to herein as assembly 400. While the vehicle frame assemblies of embodiments 100, 100′, 200, 200′ and 300 are exemplified for convenience purposes using I-beams or C-beams as indicated in those exemplary embodiments, FIG. 31 illustrates a vehicle frame assembly 400 in which the rail and crossmembers are fabricated metal sections. It should be understood to one skilled in the art that the rails and crossmembers of the various embodiments can be varied to create a variety of frame structures and that the type and size of the crossmembers and rail can further be varied as can the bracket selected without departing from the spirit and scope of the invention.

The vehicle frame assembly 400 as shown in FIG. 31 is similar to the vehicle frame assemblies of prior embodiments in that it has at least one rail 410 and a plurality of crossmembers 420. Like reference numbers are used herein to refer to analogous or corresponding components. The rails 410 and crossmembers 420 may be arranged in the same manner as discussed above with respect to the vehicle frame assemblies 100, 100′, 200, 200′ and 300. Thus, the rail 410 is arranged longitudinally and the plurality of crossmembers 420 are arranged generally transversely to the rail 410. As shown, two rails 410 are provided and are parallel and spaced apart transversely. Similarly, the crossmembers 420 are parallel and are spaced apart longitudinally. The rail 410 is arranged in a first plane and the crossmembers 420 are arranged in a second plane that is parallel to the first plane. The second plane is preferably elevated above the first plane so that the crossmembers 420 are stacked on the rails 410. The rail 410 and crossmembers 420 are preferably galvanized. More preferably, the rail 410 and crossmembers 420 are galvanized or otherwise coated prior to assembly of the vehicle frame assembly 400.

Brackets 430 are used to connect the rails 410 to the crossmembers 420 to provide a secure and stable connection without requiring welding, which may damage the galvanized coatings of the rails 410 and crossmembers 420. The brackets 430 are preferably positioned on an upper side 401 of the vehicle frame assembly 400 as shown in FIG. 31. The brackets 430 are themselves preferably also galvanized so that all components of the vehicle frame assembly 400 are galvanized.

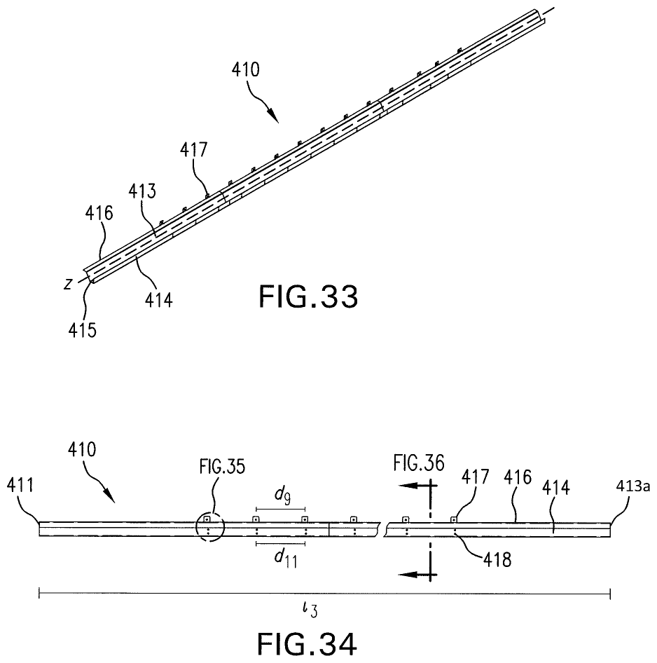

Referring now to FIGS. 33-36, there is shown a rail of the vehicle frame assembly of FIG. 31. The rail 410 is substantially linear along its longitudinal axis Z. The rail 410 has a length, l₃, as measured along the longitudinal axis Z from the first terminal end 411 to the second terminal end 413a of the rail 410. While the rails 410 of the present invention can have different configurations as discussed herein, the rail 410 in the illustrated embodiment is a fabricated metal section having a custom configuration. The rail 410 has a web 412 with a first portion 415 disposed transversely with respect to the longitudinal axis Z and a second portion 413 of the web 412 which is inclined relative to the first portion 415 such that an exterior angle, a₄, measured between the second portion 413 and an axis L extending transversely with respect to the axis Z in the plane of the first portion 415 of the web 412 is an acute angle. The first portion 415 of the web 412 includes an outer flange 414 that is oriented substantially orthogonally to the first portion 415 of the web 412. The second portion 413 of the web 412 includes an inner flange 416 that is disposed substantially transversely with respect to the longitudinal axis Z and is parallel to the first portion 415 of the web 412. When two rails 410 are used, as shown in FIG. 31, the two rails 410 are arranged such that the rails 410 are parallel and spaced apart with the inner flanges 416 facing toward one another. The rails 410 are preferably composed of aluminum or steel.

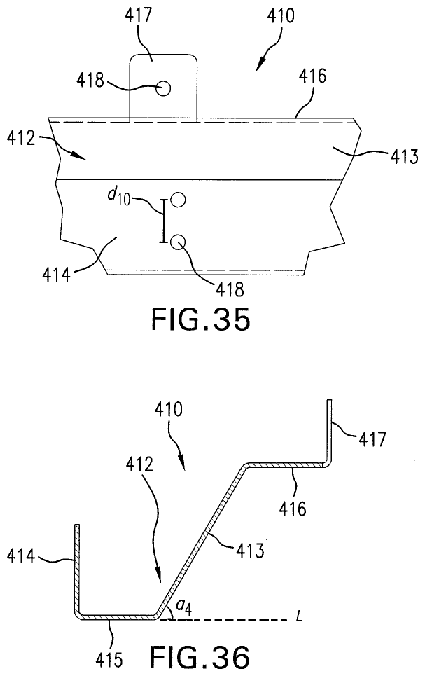

The rail 410 preferably further includes a plurality of tabs 417 positioned at intervals each of a distance, d₉, along the length of the rail 410. Preferably, d₉ is about 4 to about 10 inches. The tabs 417 are positioned substantially perpendicularly with respect to the inner flange 416 and the tabs 417 are substantially parallel, and preferably parallel, to the outer flange 414. Each tab 417 may have an aperture 418 configured to be aligned with an aperture of a bracket that connects the rail 410 to a crossmember. Further, the outer flange 414 may also have one or more apertures 418 for receiving fasteners, as shown in FIG. 35. Preferably, the apertures 418 on the outer flange 414 are arranged in pairs that are separated from one another by a spaced apart distance, d₁₀, measured in a transverse direction. Preferably, d₁₀ is about 0.5 to about 1.5 inches. Pairs of apertures 418 on the outer flange 414 are arranged along the length of the rail 410 and are separated from successive pairs of apertures by a spaced apart distance, d₁₁. Preferably, d₁₁ is about 4 to about 10 inches. The apertures 418 on the outer flange 414 are configured to be aligned with apertures of a bracket that connects the rail 410 to crossmembers 420. The apertures facilitate placement of brackets on the rail 410 and securement of the brackets to the rail 410 without the use of welding, which may damage the galvanized coating of the rail 410.

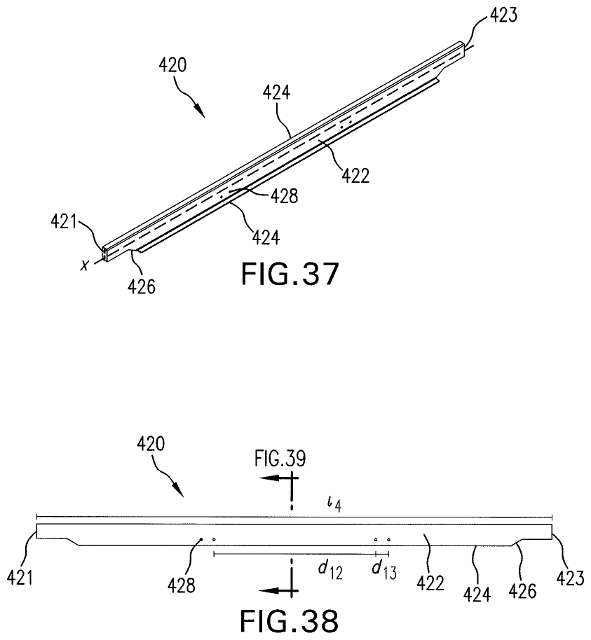

Referring now to FIGS. 37-39, there are shown views of an alternate crossmember of the vehicle frame assembly of FIG. 31. The crossmembers 420 are substantially linear along the longitudinal axis X from a first terminal end 421 to a second terminal end 423. Each of the crossmembers 420 as shown has the same shape and dimensions. Each crossmember 420 has a length, l₄, measured from the first terminal end 421 to the second terminal end 423 along the longitudinal axis X of the crossmember 420. In the illustrated embodiment, each crossmember 420 is a fabricated metal section formed by bending, cutting, stamping and/or other metal forming processes. The crossmembers 420 are preferably composed of aluminum or steel. In some embodiments, the crossmembers 420 are composed of a different material than the rail 410, and for example the rail 410 may be steel while the crossmembers 420 are aluminum.

As with prior embodiments, the positioning and location of apertures for receiving the brackets may be varied according to a designed frame assembly design, and the number of rails and crossmembers may also be varied.

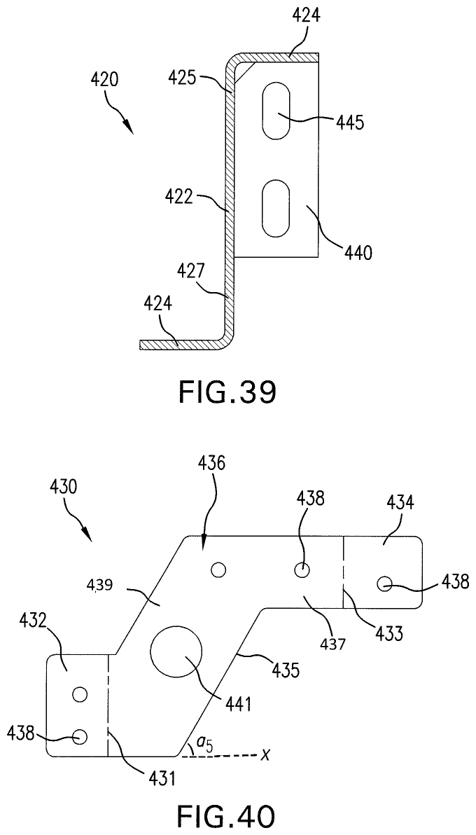

The crossmember 420 as shown has a web 422 with a first end 425 and a second end 427, with a flange 424 on each of the first and second ends 425, 427, as best shown in FIG. 39. Preferably, the flanges 424 are oriented perpendicularly to the web 422, and are substantially parallel to one another and extend in opposite directions. As shown, the flange 424 on the first end 425 of the web 422 extends in an opposing direction as the flange 424 on the second end 427. The flange 424 on the first end 425 of the web 422 is configured to support a deck or trailer, and the flange 424 on the second end 427 of the web 422 is configured to be stacked on the rail or rails 410 of the vehicle frame assembly 400.

The second end 427 of the web 422 may include a cutout 426 towards each of the first and second terminal ends 421, 423, as shown in FIG. 37, such that the web 422 is tapered towards the first and second terminal ends 421, 423. The flange 424 on the second end 427 of the web 422 may be formed so as not to extend along the cutouts 426 and not extend the full length l₄ of the crossmember 420.

As best shown in FIG. 39, the crossmember 420 further includes an end plate 440 on each of the first terminal end 421 and second terminal end 423 of the crossmember 420. Each end plate 440 is positioned perpendicularly to the web 422 of the crossmember 420 and is shown as having a generally rectangular shape. The end plates 440 are each connected to the flange 424 on the first end 425 of the web 422 of the crossmember 420 and along at least a portion of the web 422. The end plate 440 may define one or more apertures 445.

The crossmember 420 may define one or more apertures 428 for receiving fasteners therethrough as best shown in FIG. 38. The apertures 428 are provided in pairs that are aligned along the longitudinal axis X of the crossmember 420 and the apertures 428 in a pair of apertures are separated by a spaced apart distance, d₁₃. Preferably, d₁₃ is about 0.5 to about 1.5 inches. Pairs of apertures 428 are separated from successive pairs of apertures along the longitudinal axis X of the crossmember 420 by a spaced apart distance, d₁₂. Preferably, d₁₂ is about 25 to about 35 inches. The apertures 428 are configured to align with apertures of a bracket so that fasteners can be inserted through the aligned apertures 428 to connect the bracket to the crossmember 420 without the use of welding.

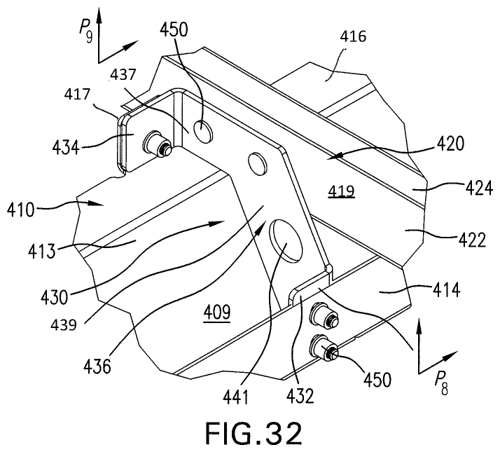

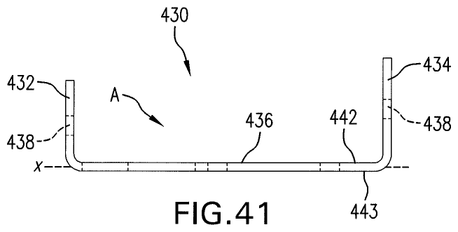

Referring now to FIGS. 31,32, 40 and 41, an embodiment of a bracket is shown for use with the vehicle frame assembly of FIG. 31. In the exemplary embodiment shown, the brackets 430 each have a first plate 432, a second plate 434 and a connection section 436. With reference to FIGS. 32 and 41, the first plate 432 is arranged in a first plane P₈ and the second plate 434 is arranged in a second plane P₉ that is substantially parallel, and preferably parallel, to the first plane P₈ and spaced therefrom. The connection section 436 extends between and connects an interior end 431 of the first plate 432 to an interior end 433 of the second plate 434. The connection section 436 bridges an area, A, between the first and second plates 432, 434. The connection section 436 is substantially perpendicular, and preferably perpendicular, to the first and second plates 432, 434. The connection section 436 is inclined and slopes upwardly from the first plate 432 toward the second plate 434, as the second plate 434 is arranged at a higher elevation than the first plate 432, as best shown in FIGS. 32 and 40. The connection section 436 includes a first portion 439 adjacent to the first plate 432 which is inclined, and a second portion 437 adjacent to the second plate 434 that is parallel to a longitudinal axis X of the bracket 430. The first portion 439 of the connection section 436 is inclined at an angle, a₅, relative to the longitudinal axis X of the bracket 430 as shown in FIG. 40. Angle a₅ is substantially the same, and preferably the same, as the angle a₄ of an inclined portion 413 of a web 412 of a rail 410 of the vehicle frame assembly 400 to which the bracket is configured to be connected. The connection section 436 is configured to be in at least partial facing engagement with the web 412 of the rail 410 to which it is connected in order to provide the frame assembly 400 with additional support and stability. Preferably, an edge 435 of the connection section 436 is in at least partial facing engagement with the web 412 of the rail 410.

The bracket 430 is preferably formed from metal, such as aluminum or steel, and may alternately be composed of a composite material. The bracket 430 may be galvanized and/or coated to inhibit corrosion and wear, to improve surface properties, and to provide a desired aesthetic appearance. The bracket 430 may be of unitary construction and may be formed by bending a blank as shown in FIG. 40 formed from a sheet or plate into the desired configuration. However, the present invention is not limited by the specific method of forming the bracket and the brackets may alternatively be formed by molding.

The first plate 432, the second plate 434 and the connection section 436 may each define one or more apertures 438 extending through the bracket 430 from a first surface 442 to an opposing surface 443 of the bracket 430. The first plate 432 is shown as defining a pair of apertures 438 that are aligned in a direction extending transversely to the longitudinal axis X of the bracket 430. The second plate 434 is shown as defining a single aperture 438. The connection section 436 is shown as defining a pair of apertures 438 aligned along the longitudinal axis X of the bracket 430, which are positioned towards the second plate 434 of the bracket 430 and on the second portion 437 of the connection section 436. However, in alternate embodiments, the first plate, second plate and connection section 432, 434, 436 may define additional or fewer apertures which may be variously arranged on the first plate, second plate and connection section 432, 434, 436. In the illustrated embodiment, each of the apertures 438 are shown as having a generally circular shape and each aperture has the same shape and dimensions.

The apertures 438 on each of the first plate, second plate and connection section 432, 434, 436 are configured and positioned to receive respective fasteners for securing the bracket 430 to a rail 410 or crossmember 420. Additional apertures may be included to allow for the use of additional fasteners to provide a stronger connection, or to provide options as to which apertures to align with the corresponding apertures on a rail or crossmember. Any of various fasteners 450 may be used to connect the bracket 430 to the rail 410 and crossmembers 420 as discussed above with respect to vehicle frame assemblies 100, 200, 300, such as rivets, pins, bolts, locking bolts, threaded rods and the like. As shown, the aperture in the second plate 434 is positioned to align with the aperture in the tab 417, the apertures in the first plate are positioned to align with similarly positioned apertures in the flange 414, and the apertures in the second portion 437 of the connection section 436 are positioned and configured for alignment with apertures incorporated in the web 422 of the crossmembers.

The connection section 436 may further define one or more openings 441. In FIG. 40, one opening 441 is shown and has a substantially circular shape. The opening 441 is preferably larger in diameter than the apertures 438, as the opening 441 may receive wires or cables therethrough that extend along the rail 410 to which the bracket 430 is connected.

To connect a rail 410 to a crossmember 420, the brackets 430 are preferably positioned on an upper side 401 of a vehicle frame assembly, as shown in FIGS. 31-32. The first plate 432 of the bracket 430 is configured to engage a first surface 409 of the rail 410, and may be in facing engagement therewith. Preferably, the first plate 432 of the bracket 430 engages the outer flange 414 of the rail 410 and is in facing engagement therewith. The connection section 436 is inclined and slopes upwardly towards the second plate 434, and is preferably inclined at the same or a similar angle as the web 412 of the rail 410. The connection section 436 is also arranged to be positioned substantially perpendicularly to the longitudinally extending web 412 of the rail 410 and is in at least partial facing engagement with the web 412 of the rail 410. Preferably, an edge 435 of the connection section 436 is in facing engagement with the web 412 of the rail 410. In this way, the bracket 430 generally contours to the profile and shape of the rail 410 and fits closely against the rail 410 to facilitate proper alignment of the rail 410 and crossmember 420. Further, the connection section 436 engages a surface 419 of the crossmember 420. Preferably, the connection section 436 is in at least partial facing engagement with the web 422 of the crossmember 420. Specifically, the second portion 437 of the connection section 436 may be in facing engagement with the web 422 of the crossmember 420. The second plate 434 of the bracket 430 engages a tab 417 of the rail 410 and is preferably in facing engagement with the tab 417. Thus, the first and second plates 432, 434 of the bracket 430 connect to opposing sides of the rail 410 and the connection section 436 connects to the web 422 of the crossmember 420.

In embodiments of the bracket 430 having apertures, the apertures 438 on the first plate 432 of the bracket 430 are situated to sit in alignment with the apertures 418 on the outer flange 414 of the rail 410. Apertures 438 on the connection section 436 of the bracket 430 are situated to sit in alignment with apertures 428 on the web 422 of the crossmember 420. Additionally, an aperture 438 on the second plate 434 of the bracket 430 is situated to sit in alignment with an aperture 418 of the tab 417 of the rail 410. Fasteners 450 as discussed above with respect to the other vehicle frame assemblies of the present invention can be inserted through the aligned apertures to secure the bracket 430 to the rail 410 and crossmember 420. In embodiments of the brackets 430 not having apertures, the bracket 430 may be secured to the rail 410 and crossmembers 420 by alternative fastening methods known in the art, such as the use of adhesives or welding.

The present invention further relates to methods for forming a vehicle frame assembly. The method includes providing at least one rail, a plurality of crossmembers, and a plurality of brackets. The rails and crossmembers may have the configuration and features as described above with respect to the vehicle frame assemblies, which may be any of the rails, crossmembers and brackets described herein in the various embodiments, including in embodiments 100, 100′, 200, 200′, 300 and 400. Further, the plurality of brackets may include any of the brackets of the type described herein having a first plate, a second plate, and a connection section for connecting the first plate and the second plate.

The rail and/or the crossmembers may be galvanized. Preferably, the rail and/or crossmembers are galvanized prior to assembling the vehicle frame assembly. The rails and crossmembers may be galvanized by spray coating or by a dipping process. It is understood that the present invention is not limited by the particular method by which the vehicle frame assembly components are galvanized. Alternate or additional coatings can also be applied to the rail and/or crossmembers prior to assembly of the vehicle frame assembly to inhibit corrosion and wear, to provide improved surface properties, and/or to improve the aesthetic appearance of the rail and crossmembers. The brackets may also be galvanized.

To assemble the vehicle frame assembly, the rail is arranged longitudinally and the crossmembers are arranged transversely to the rail. Preferably, the rail is arranged in a first plane and the crossmembers are arranged in a second plane that is parallel to the first plane. The second plane is preferably located above the first plane so that the crossmembers are stacked on the rail. However, in various alternate embodiments, the second plane may be located below the first plane so that the rail is stacked on the crossmembers.

The brackets are used to connect the rail to the crossmembers. Each bracket connects a surface of a rail to a surface of a crossmember. The brackets may be installed on an upper side and/or lower side of the vehicle frame assembly depending on the cross members employed as described above. Preferably, a first plate of the bracket engages a surface of a rail or crossmember and the second plate of the bracket engages the other of a rail or crossmember so that two corresponding members (rail and crossmember) of the assembly can be joined. In one embodiment, the bracket is configured so that the first plate is perpendicular to the second plate of the bracket, such that on an upper side of the vehicle frame assembly, the first plate can be engaged with a flange of a rail and the second plate can be engaged with a web of a crossmember. Such an embodiment is shown, for example in embodiments 100, 100′ 200 and 200′. Alternatively, the bracket configured in this manner may be installed on the lower side of the vehicle frame assembly so that the first plate can be engaged with a flange of a crossmember and the second plate can be engaged with a web of a rail.

In another embodiment, the bracket is configured so that the first plate is in a plane that is substantially parallel to a plane in which the second plate is arranged, and the first and second plates are connected by the connection section. Examples of such a bracket are shown in embodiments 300 and 400. In such embodiments, the first plate may be connected to a flange of a rail and the second plate may be connected to a flange of a crossmember as in embodiment 300 or to a flange in the form of a tab on the rail as in embodiment 400. In such embodiments, the connection section may be angled or perpendicular to the first and second plates.

In a further embodiment, the bracket is configured so that the first plate is parallel to the second plate and the connection section is perpendicular to both the first and second plates, and the first plate may be connected to an outer flange of a rail and the connection section may be connected to a web of a crossmember, and optionally the second plate may be connected to a flange in the form of a tab of the rail.

In each embodiment of the bracket, the first plate and the second plate of the bracket may be and preferably are in facing engagement with the surface of the rail or crossmember to which they are connected. Alternatively, the first plate or second plate of the bracket may be separated from the surface of the rail or crossmember, such as by a gasket or spacer. The connection sections may also be in at least partial facing engagement with a flange or web over which the connection section is positioned while bridging the area between the plates.

Regardless of the embodiment of the bracket used, fasteners of the type described herein with respect to the vehicle frame assemblies may be used to secure the brackets to the rail and crossmembers. The brackets may include apertures on the first and second plates for receiving the fasteners, and preferably the rail and crossmembers also include apertures that can be aligned with the apertures of the bracket to facilitate proper positioning of the brackets and installation of the fasteners. The first and second plates may alternatively secured to the surfaces of the rail and crossmembers by the use of adhesives or welding. Further, rivets can be driven through the first or second plate of the bracket and through the web or flange of the rail or crossmember to which the first or second plate is to be connected.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-21. (canceled)

22. A vehicle frame assembly, comprising:
a plurality of crossmembers arranged generally transversely and at least one rail extending generally longitudinally with respect to the plurality of crossmembers;
a plurality of brackets for connecting the plurality of crossmembers to the at least one rail, wherein each bracket comprises a first plate, a second plate and a connection section configured to bridge an area between the first plate and the second plate;
wherein the first plate of each bracket is configured to engage and be secured to a surface of the at least one rail and the connection section is configured to be in at least partial engagement with a surface of a crossmember of the plurality of crossmembers; and
wherein at least one of the plurality of crossmembers and the at least one rail are galvanized.

23. The vehicle frame assembly of claim 22, wherein the plurality of crossmembers and the at least one rail are pre-galvanized before the assembly is made.

24. The vehicle frame assembly of claim 22, wherein the plurality of crossmembers and the at least one rail are formed from fabricated metal sections.

25. The vehicle frame assembly of claim 22, wherein the at least one rail comprises a web with an outer flange and an inner flange.

26. The vehicle frame assembly of claim 25, where the at least one rail further includes at least one tab, each tab being positioned on the inner flange of the rail and aligned so as to engage the second plate of one of the plurality of brackets and securing the second plate of each bracket to the tab of the at least rail.

27. The vehicle frame assembly of claim 22, wherein each of the plurality of crossmembers comprises a web with a first end and a second end, and a flange arranged perpendicularly to the web of the crossmember extends outwardly on each of the first end and the second end of the web of the crossmember, and wherein the flanges of the crossmembers extend in opposing directions.

28. The vehicle frame assembly of claim 22, wherein there are two rails.

29. The vehicle frame assembly of claim 28, wherein the two rails are arranged in a first plane and the plurality of crossmembers are arranged in a second plane that is substantially parallel to the first plane.

30. The vehicle frame assembly of claim 22, wherein the first plate and second plate of each bracket of the plurality of brackets are parallel and the connection section connects an interior end of the first plate to an interior end of the second plate, and the connection section is perpendicular to the first plate and the second plate.

31. The vehicle frame assembly of claim 30, wherein on an upper side of the assembly, the first plate of each bracket of the plurality of brackets is connected to a flange of a rail of the at least one rail, and the connection section extends over a web of the rail and is connected to a web of a crossmember of the plurality of crossmembers.

32. The vehicle frame assembly of claim 22, wherein the brackets are secured to the rails and crossmembers by fasteners.

33.-39. (canceled)

40. A method of forming a vehicle frame assembly, comprising:
providing at least one rail, a plurality of crossmembers, and a plurality of brackets, wherein each of the brackets comprises a first plate, a second plate and a connection section bridging an area between first plate and the second plate;
galvanizing the at least one rail and/or the plurality of crossmembers;
assembling the vehicle frame assembly by arranging the at least one rail generally longitudinally and the plurality of crossmembers generally transversely to the at least one rail; and
connecting each crossmember of the plurality of crossmembers to one rail of the at least one rail by engaging and securing the first plate of each brackets of the plurality of brackets with a surface of the at least one rail, and engaging and securing the connection section of each of the brackets of the plurality of brackets with a surface of the crossmember of the plurality of crossmembers.

41. The method of forming a vehicle frame assembly of claim 40, further comprising engaging and securing a second plate of each bracket of the plurality of brackets with a tab of the at least one rail.

42. The method of forming a vehicle frame assembly of claim 40, further comprising connecting the first plate of each bracket to an outer flange of the at least one rail, and connecting the connection section to a web of the crossmember of the plurality of crossmembers.

43. The method of forming a vehicle frame assembly of claim 40, further comprising securing the plurality of brackets to the at least one rail and the plurality of crossmembers using fasteners.

44.-52. (canceled)

53. A bracket for assembling a vehicle frame assembly, comprising:
a first plate, a second plate, and a connection section connecting an interior end of the first plate to an interior end of a second plate and bridging an area between the first plate and the second plate, wherein the first plate and the second plate are substantially parallel to one another and the connection section is perpendicular to the first plate and the second plate, wherein the first plate is configured such that upon installation of a vehicle frame assembly, the first plate is able to engage and be secured to a rail of a vehicle frame assembly and the connection section is configured for engaging and being secured to a web of a crossmember of a vehicle frame assembly.
